(19) United States
(12) Patent Application Publication
(10) Pub. No.: US 2025/0299038 A1
(43) Pub. Date: Sep. 25, 2025

(54) INFORMATION PROCESSING APPARATUS

(71) Applicant: CANON KABUSHIKI KAISHA, Tokyo (JP)

(72) Inventors: YOSHINORI MIZOGUCHI, Tokyo (JP); TAKASHI NAKAMURA, Kanagawa (JP); TAKAYUKI YAMADA, Kanagawa (JP); KAZUFUMI KONDO, Kanagawa (JP); AKITOSHI YAMADA, Kanagawa (JP); HISASHI ISHIKAWA, Chiba (JP)

(21) Appl. No.: 19/080,473

(22) Filed: Mar. 14, 2025

(30) Foreign Application Priority Data
Mar. 19, 2024 (JP) 2024-043546

(51) Int. Cl. G06N 3/08; G06F 17/15

(52) U.S. Cl. CPC G06N 3/08; G06F 17/15

(57) ABSTRACT

An information processing apparatus includes: an obtainment unit configured to obtain target data from data for inference inputted in the information processing apparatus; and a computation unit configured to execute convolutional computation and output computation result data, the convolutional computation using computation data including the target data obtained by the obtainment unit and margin data different from the target data that is required to obtain the computation result data in a predetermined size, in which, according to a data obtainment condition set in advance, the obtainment unit obtains first data, which is a part of the margin data, from a data group existing around the target data in the data for inference and doses not obtain second data, which is the margin data except the first data, from the data group, and a coefficient of the convolutional computation is determined by learning to which the data obtainment condition is reflected.

### BACKGROUND OF THE DISCLOSURE

### Field of the Disclosure

The present disclosure relates to inference and learning using a convolutional neural network.

### Description of the Related Art

There is a convolutional neural network (CNN) as one of favorable methods for pattern recognition. In inference using the CNN, a massive amount of convolutional computations are repeatedly executed by using a filter including multiple layers to extract a specific feature. Additionally, a coefficient of the filter (also referred to as a weight) used in the inference is determined by learning using the CNN. In the learning, the filter coefficient is repeatedly updated so as to extract the specific feature based on an error between a feature amount vector extracted by the CNN and a correct answer prepared in advance. With this processing, an optimized filter coefficient is determined. The inference and the learning as described above cause a massive amount of computations, and a hardware resource that corresponds to the computation amount is required. On the other hand, since reduction in size and cost is demanded as a product, a sufficient hardware resource is not always provided. Particularly, an SRAM that is used as the filter of the CNN tends to need a high cost to increase an area of an integrated circuit, and reduction of the capacity has been an issue.

To deal with this issue, Japanese Patent Laid-Open No. 2021-012553 (PTL 1) discloses a technique of decomposing a weight matrix (filter) of the machine learning model into multiple matrices having a predetermined width so as to change a size of a machine learning model into an arbitrary size while maintaining the inference accuracy as much as possible. Additionally, a method called zero padding has been also known as the technique of reducing the SRAM capacity. In the convolution of an image, a sum of products is locally computed in an input image while scanning a square filter, and values are aggregated into a pixel in the center of the filter. However, in a case where the filter is near an end portion of the input image, a part of the filter sticks out to the outside of an image region. The zero padding is processing in which the sticking out peripheral pixel is not obtained from the input image but padded with “0”. That is, with the zero padding, it is unnecessary to hold the data of the peripheral region of the input image in the SRAM, and the capacity of the SRAM is reduced.

However, in a case where the zero padding is performed to reduce the SRAM capacity, there is an issue of decline in reliability of the computation result because data that is not a true value is included in the data used for the convolutional computation. That is, in the implementation of the CNN to the product, there is an issue that the implementation is difficult because of restriction of the hardware resource if the reliability of a computation result is tried to be enhanced, and the reliability of the computation result is declined if a method that allows for the implementation is selected. Additionally, in general, the filter coefficient of the CNN implemented on a product is a learned value, which is generated in advance by a learning apparatus different from the product. Therefore, in order to perform the inference accurately in the product, it is demanded to perform the learning assuming input data in the inference also in the learning that is performed in advance.

### SUMMARY OF THE DISCLOSURE

An object of the present disclosure is to reduce a storage capacity required for computation of a CNN while suppressing decline in reliability of a computation result.

The present disclosure is an information processing apparatus configured to execute inference using a convolutional neural network, including: an obtainment unit configured to obtain target data from data for inference inputted in the information processing apparatus; and a computation unit configured to execute convolutional computation and output computation result data, the convolutional computation using computation data including the target data obtained by the obtainment unit and margin data different from the target data that is required to obtain the computation result data in a predetermined size, in which, according to a data obtainment condition set in advance, the obtainment unit obtains first data, which is a part of the margin data, from a data group existing around the target data separately from the target data in the data for inference and doses not obtain second data, which is the margin data except the first data, from the data group, and a coefficient of the convolutional computation is determined by learning to which the data obtainment condition is reflected.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a printer, which is an example of an information processing apparatus;

FIG. 2 is a conceptual diagram illustrating an example of a model structure of a CNN forming an inference unit;

FIG. 3 is a conceptual diagram illustrating an internal configuration of a filter;

FIG. 4 is a diagram illustrating a functional configuration and a data processing process of the inference unit;

FIG. 5 is a diagram describing division of image data and peripheral data of a division image block;

FIG. 6 is a flowchart describing a flow of inference;

FIG. 7 is a diagram illustrating a data obtainment method as a comparative example;

FIG. 8 is a flowchart describing a flow of convolutional computation processing in a case of FIG. 7;

FIGS. 9A and 9B are diagrams describing a calculation procedure of the convolutional computation in a case of FIG. 7;

FIG. 10 is a diagram illustrating the data obtainment method according to a first embodiment of the present disclosure;

FIG. 11 is a flowchart describing a flow of the convolutional computation processing in a case of FIG. 10;

FIGS. 12A and 12B are diagrams describing a calculation procedure of the convolutional computation in a case of FIG. 10;

FIGS. 13A and 13B are diagrams describing a method of accessing a DRAM;

FIG. 14 is a diagram illustrating the data obtainment method according to a modification 1 of the first embodiment;

FIGS. 15A and 15B are diagrams describing a calculation procedure of the convolutional computation in a case of FIG. 14;

FIG. 16 is a diagram illustrating the data obtainment method according to a modification 2;

FIG. 17 is a diagram illustrating an example of the peripheral data spanning multiple lines;

FIG. 18 is a diagram illustrating the data obtainment method according to a modification 3;

FIGS. 19A and 19B are diagrams illustrating a relationship between the printer as an inference apparatus and a learning apparatus;

FIG. 20 is a diagram illustrating an example of a hardware configuration of the learning apparatus;

FIG. 21 is a diagram illustrating a functional configuration and a data processing process of the learning apparatus;

FIG. 22 is a schematic diagram illustrating the vicinity of an input unit of a typical CNN model;

FIG. 23 is a schematic diagram illustrating an overview of a processing unit in a processing layer;

FIG. 24 is a schematic diagram illustrating the vicinity of an output unit of the CNN;

FIG. 25 is a flowchart describing an overall flow of learning processing executed by the learning apparatus;

FIG. 26 is a diagram illustrating an example of a UI screen to set a model structure and a model condition;

FIG. 27 is a flowchart describing a flow of the learning processing;

FIG. 28 is a diagram describing division and augmentation of learning data;

FIG. 29 is a flowchart describing an overall flow of the learning processing in a third embodiment;

FIG. 30 is a diagram illustrating a system configuration and a functional configuration of an information processing system in the third embodiment;

FIG. 31 is a diagram illustrating a UI screen of printing setting as an example of use case setting; and

FIG. 32 is a diagram illustrating a system configuration and a functional configuration in a modification of the third embodiment.

### DESCRIPTION OF THE EMBODIMENTS

An embodiment to implement the present disclosure is described below with reference to the drawings. Hereinafter, with reference to the attached drawings, the present disclosure explains some example embodiments in detail. Configurations shown in the following embodiments are merely exemplary and some embodiments of the present disclosure are not limited to the configurations shown schematically. First, a term used herein is described.

### Term Definition

### Neuron:

A neuron is a unit of processing including a filter and an activating function. A coefficient of the filter is referred to as a “filter coefficient”, a “weight”, a “weight of neuron”, and the like. The neuron executes convolutional computation by using data as a target of computation processing executed by the filter (hereinafter, referred to as “computation data”) and obtains “computation result data”. The “computation data” includes “target data” and “margin data”. The “target data” herein is data of an image block obtained by dividing image data for inference or learning data (for example, image data in a page unit) inputted from the outside into a predetermined size. The image data in the page unit that is an original of the obtained target data is also referred to as an “original image”. The unit of the original image is not limited to the page unit, and it is arbitrary. The “margin data” is data that exists in an outer periphery of the target data while sticking out from the filter in the convolutional computation for the target data. A width of the margin data is determined by a filter size and a model structure including a layer structure. For example, in a case of using a 3×3 filter, data including the target data and the margin data of one line each on the right, left, top, and bottom (rows and columns) around the target data is the computation data. Additionally, for example, in a case of using a 5×5 filter, data including the target data and the margin data of two lines each on the right, left, top, and bottom (rows and columns) around the target data is the computation data. In any case, the size of the computation result data is the same size as the target data. Additionally, “reference data” (first data) is data out of the margin data that is obtained from the original image by the inference unit. The reference data is real data obtained from a data group existing around the target data (the image block) in the original image. Note that, the filter size and the data size are examples for description. The values are not limited thereto and may be an arbitrary value. Note that, in the present disclosure, data (second data) except the reference data out of the margin data is not obtained from the above-described data group; details are described later. Moreover, “input data” is a data group including the “target data” and the “reference data”, which is obtained from the original image and held in an SRAM of the inference unit.

### Activating Function:

An activating function is a function having non-linear response characteristics. A sigmoid function, a ReLU function, and the like are often used. This is because the relationship between input and output is expected to have the non-linear response characteristics.

### Layer:

A layer is a unit of processing including multiple neurons. In principle, common computation data is inputted to each of the neurons. Note that, different weights may be set as the filter coefficient (the weight) of each neuron according to the feature demanded to be obtained. The reason the layer includes multiple neurons is to analyze the computation data from multiple aspects.

### Feature Amount:

An output from one neuron is called a feature amount. Different neurons output the feature amounts at different intensities.

### Feature Amount Vector:

It is a vector including the feature amount outputted from one layer. Hereinafter, a degree of the vector is also referred to as a “channel”. A “dimension” and the “channel” are used appropriately depending on the context. This is because the appropriate term for the context changes depending on the convention.

In the following embodiment, a printer is used as an example to describe an embodiment of an information processing apparatus and embedded equipment according to the present disclosure. Note that, the present disclosure is not limited to the printer. In addition to an image formation apparatus such as a multifunction peripheral (MFP), the present disclosure is applicable to various image processing apparatuses such as image capturing equipment and video equipment and a general information processing apparatus such as a PC and a smartphone. Additionally, although the image data is used as an example in the descriptions below, the data as a processing target in the present disclosure is not limited to two-dimensional data represented by the image data, and the present disclosure is also applicable to chronological one-dimensional data such as sound data. In this case, the present disclosure is also applicable to acoustic equipment, lighting equipment, and the like as the embedded equipment.

### First Embodiment

In a first embodiment, a printer is described as an example of an information processing apparatus that executes inference using a convolutional neural network (CNN).

### Hardware Configuration

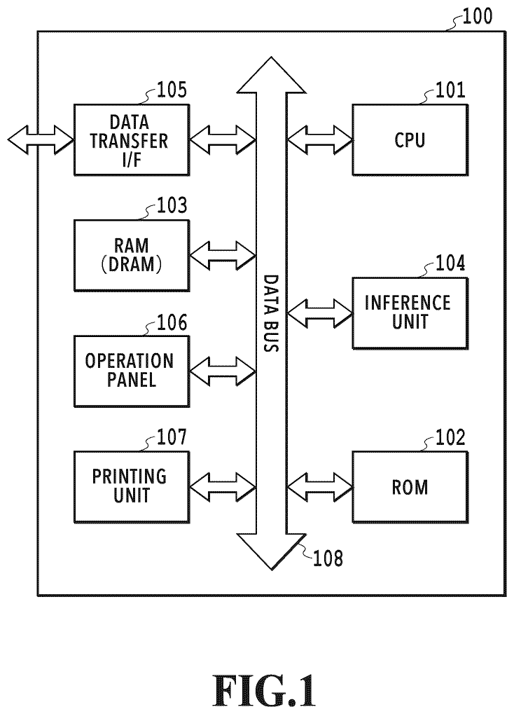

FIG. 1 is a block diagram illustrating a hardware configuration of a printer, which is an example of an information processing apparatus according to the present embodiment. As illustrated in FIG. 1, a printer 100 includes a CPU 101, a ROM 102, a RAM 103, an inference unit 104, a data transfer I/F 105, an operation panel 106, and a printing unit 107. The ROM 102, the RAM 103, the inference unit 104, the data transfer I/F 105, the operation panel 106, and the printing unit 107 are connected to the CPU 101 via a data bus 108.

The data transfer I/F 105 is an interface that inputs and outputs data to and from not-illustrated external equipment. A connection system in the data transfer I/F 105 is not particularly limited, and a USB, IEEE 1394, and the like can be used, for example. Additionally, either wired or wireless may be applicable. The external equipment is a personal computer, a portable information terminal, a smartphone, or the like, for example, which is equipment that can generate and hold image data as a target of the inference and transfer the image data to the printer 100. The data transfer I/F 105 transfers the image data for inference inputted from the external equipment to the CPU 101 via the data bus 108.

The data bus 108 is a data transmission line that inputs the image data for inference received from the data transfer I/F 105 to the CPU 101 and transfers the data outputted from the CPU 101 to each unit in the printer 100. The RAM 103 is a storage region that temporarily stores the data received from the data transfer I/F 105 and is formed of a volatile memory such as a dynamic random access memory (DRAM), for example. Additionally, the RAM 103 is used as a working memory for processing executed by the CPU 101.

The CPU 101 calls a program held in the ROM 102 to deploy to the RAM 103 and executes processing according to the program while using the RAM 103 as the working memory. For example, the CPU 101 transfers the image data for inference held in the RAM 103 to the inference unit 104 via the data bus 108. Additionally, the CPU 101 sets information required for the inference such as a division condition of the image data for inference, a reference data obtainment condition, a padding condition, and a filter coefficient to the inference unit 104. These pieces of information may be held in advance in the ROM 102 as a parameter or may be set by the program.

The inference unit 104 sets the filter coefficient inputted from the CPU 101 to the filter. Additionally, based on the division condition, the reference data obtainment condition, and the padding condition, the inference unit 104 obtains computation data from the image data for inference in a predetermined unit size that is held in the DRAM 103. The inference unit 104 executes convolutional computation using the filter coefficient by using the obtained computation data and obtains computation result data. With repeated execution of the multiple types of filtering processing as described above, the inference unit 104 outputs a feature amount vector as a result of the inference and transfers the feature amount vector to the CPU 101. Details of a configuration and processing of the inference unit 104 are described later.

The ROM 102 is a non-volatile memory and holds the program, an operating system (OS), and data required for processing according to the present embodiment. The program includes a processing program for the CPU 101 to cause the inference unit 104 to execute the inference by the CNN. Additionally, the ROM 102 holds the information required for the inference such as the division condition of the image data for inference, the reference data obtainment condition, the padding condition, and the filter coefficient. The inference and these pieces of information are described later. Note that, in the present embodiment, a value that is learned in advance by a learning apparatus different from the printer 100 is stored as the filter coefficient in the ROM 102.

Based on an instruction from the CPU 101, the printing unit 107 operates a printing operation. A printing system of the printing unit 107 is not particularly limited and may be an ink jet system or an electrophotographic system, for example.

Note that, a configuration of the above-described printer 100 is an example, and the present disclosure is not limited thereto. For example, an arbitrary storage medium may be used instead of the ROM 102. The arbitrary storage medium may be an HDD or an external memory via a USB interface, for example. Additionally, in the present embodiment, the inference is executed by the inference unit 104. However, firmware that implements processing similar to the processing executed by the inference unit 104 may be stored in the storage medium, and the processing by the inference unit 104 may be executed with the CPU 101 executing the firmware. Moreover, as a part of function enhancement, a block size (a division size) of the target data that is obtained by the inference unit 104 may be a parameter that can be set by the user.

The operation panel 106 includes an input unit for the user to input an operation to the printer 100 and a display unit that displays various types of information such as a state of the printer 100 and setting information for the printer 100. The input unit is formed of a touch panel, a hardware key, or the like, for example, to input the inputted information to the CPU 101. The display unit includes a display such as an LCD and a display control circuit to display the information inputted from the CPU 101 on the display.

### (Inference Unit)

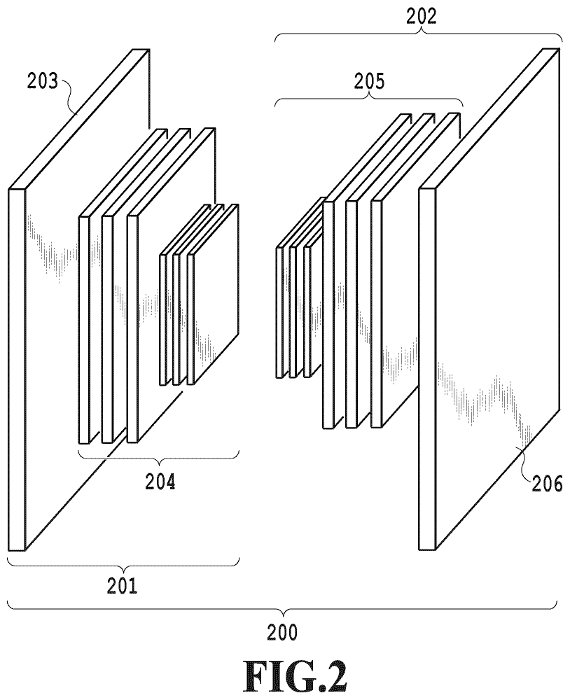

FIG. 2 is a conceptual diagram illustrating an example of a model structure of the convolutional neural network (CNN) forming the inference unit 104. The inference unit 104 includes an encoder unit 201 and a decoder unit 202 to execute the inference using the CNN. The encoder unit 201 is an aggregate of some processing layers described later. A feature of the data as the processing target is encoded through the whole encoder unit 201. The decoder unit 202 decodes a processing result obtained by the encoder unit 201 and extracts the feature amount vector.

An input layer 203 of the encoder unit 201 is the first processing layer that processes the data as the processing target. Although the processing layer is formed of multiple filters, the multiple filters are not necessarily required as hardware. The multiple filters may be implemented by repeatedly using one filter prepared as hardware. That is, although one filter is applied as hardware including an SRAM, a computation circuit, and a register, two types of sequential filtering processing is implemented by progressively updating the filter coefficient and using a computation result in one filter as input data of the next filter. The input layer 203 is illustrated as an example of the layer mentioned above. An intermediate processing layer 204 subsequent to the input layer 203 is a layer that implements the subsequent processing in response to the computation result of the input layer 203. The intermediate processing layer 204 is also formed of multiple filters as with the input layer 203. The encoder unit 201 encodes the image data as the processing target by executing the multiple types of filtering processing as described above.

As with the encoder unit 201, multiple processing layers 205 for performing the multiple types of filtering processing are provided on also a decoder unit 202 side. The final output from the processing layers 205 of the decoder unit 202 is uniquely determined by the activating function in a final layer 206 of the decoder unit 202. Thus, probability of an attribute of an interest pixel is determined for the image data as the processing target. As described above, some layers are formed by combining multiple neurons in the CNN, and encoding and decoding are performed with the combination of the formed multiple layers. The feature amount vector is obtained through the above-mentioned processing.

### (Configuration of Filter)

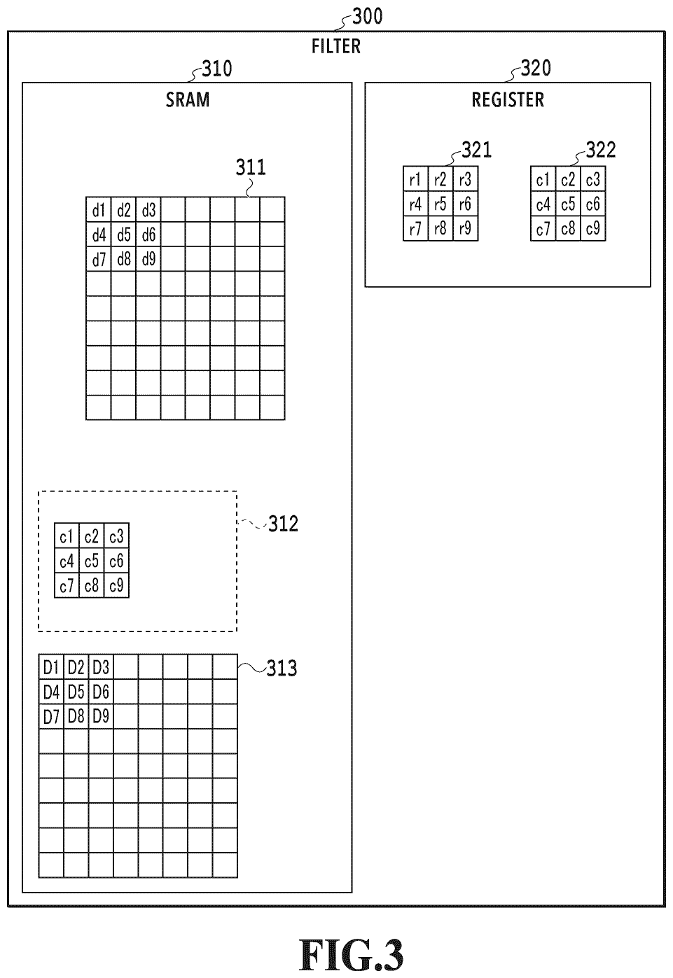

FIG. 3 is a conceptual diagram illustrating an internal configuration of the filter forming the inference unit 104 illustrated in FIG. 2. A filter 300 includes an SRAM 310 to which input data, output data, and a filter coefficient group are deployed, a coefficient register 322 to which the filter coefficient used for the convolutional computation is set, and a computation register 321 to which data of a computation range (a computation window) is deployed. As described above, the inference unit 104 includes one or more filters 300 to extract one or more features. Note that, in order to implement the multiple filters, the inference unit 104 may include multiple filters 300 as hardware, or one filter 300 may be repeatedly used while changing the filter coefficient. In either case, the inference unit 104 may be equipped with a filter required to form and execute the CNN illustrated in FIG. 2.

In the following description, the SRAM 310 includes an input data region 311, a filter coefficient region 312 holding the filter coefficient, and an output data region 313 holding a processing result of the convolutional computation. In the present embodiment, the target data cut out from the image data held in the DRAM 103 and the reference data that is a part of margin data required for the convolutional computation of the target data are deployed to the input data region 311. These target data and reference data are called input data. Although the target data is divided data cut out from the image data (the image data for inference) held in the DRAM 103, the target data is not necessarily the divided data. The image data held in the DRAM 103 is image data in a unit of a page size, for example.

The target data is the image data of one block that is obtained by dividing the image data for the inference of image data of one page into multiple blocks, and the division size may be arbitrary. For example, data of one page may be divided in vertical and horizontal directions in the form of tiles or may be divided in only one direction, vertical or horizontal, in the form of a strip. In the following description, the image blocks after the division are referred to as the target data. The inference unit 104 can reduce the capacity of the SRAM 310 by dividing the image data held in the DRAM 103 into multiple image blocks and deploying the image blocks to the SRAM 310 of the filter 300. In the example in FIG. 3, the image blocks of eight pixels×nine pixels are deployed to the input data region 311 of the SRAM 310.

Note that, preferably, the division size is determined according to the capacity of the SRAM 310. A required amount of the data is read from the DRAM 103 according to the unit of processing and deployed to the SRAM 310. Although the image blocks of eight pixels× nine pixels are deployed in FIG. 3, data of a greater size is usually deployed to the input data region 311 in actuality. Additionally, in the present disclosure, the unit of processing in the inference unit 104 is not necessarily limited to the divided image blocks and may be the image data in the page unit held in the DRAM 103.

The filter coefficient region 312 of the SRAM 310 holds the filter coefficient. The filter coefficient is obtained from the ROM 102 and held in the SRAM 310. FIG. 3 illustrates a case where a size of the filter coefficients (hereinafter, a filter size) is 3×3. Although FIG. 3 illustrates an example in which one filter coefficient is held, the filter coefficient region 312 holds multiple filter coefficients that are used in the multiple filters included in the CNN, respectively. During the execution of the convolutional computation, one filter coefficient used for the convolutional computation under execution that is out of the multiple filter coefficients held in the filter coefficient region 312 is set to the coefficient register 322. Note that, the method of holding the filter coefficient in the SRAM 310 is not limited to this example, and one filter coefficient may be held in one SRAM 310.

First, data of the computation range of the filter size out of the input data deployed to the input data region 311 of the SRAM 310 is set to the computation register 321. One filter coefficient used for the convolutional computation out of the filter coefficients held in the filter coefficient region 312 of the SRAM 310 is set to the coefficient register 322. In the convolutional computation, the data held in the computation register 321 is multiplied by the coefficient held in the coefficient register 322 and updated to a value of a multiplication result. The sum of values of all the multiplication results held in the computation register 321 is aggregated in the central pixel of the computation range and outputted as a convolutional computation result. This convolutional computation result (output data) is held in a corresponding pixel position in the output data region 313 of the SRAM 310. The above-mentioned computation processing is repeated while sliding the computation range in a predetermined sliding direction. The above processing is referred to as filtering processing of the computation data. The filtering processing is described later.

Note that, the method of holding the data illustrated in FIG. 3 is an example, and the data may be held by another aspect. For example, although an example in which the data of the computation range and the data of the multiplication result are held in the same computation register 321 is described in FIG. 3, it is not limited thereto, and the data of the computation range and the data of the multiplication result may be held in different registers, respectively. Additionally, although the result of the convolutional computation is held in the output data region 313 in the SRAM 310 the same as the SRAM 310 holding the input data, it is not limited thereto, and the result of the convolutional computation may be held in a memory different from the input data region 311 (an SRAM, the DRAM 103, or the like).

### (Data Processing Process)

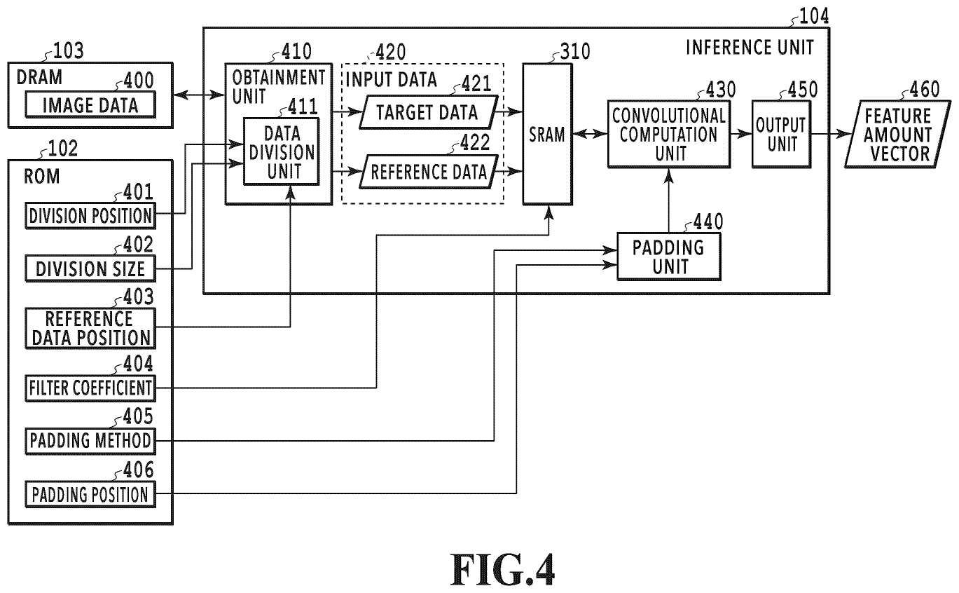

FIG. 4 is a block diagram illustrating a functional configuration and a data processing process of the inference unit 104. As illustrated in FIG. 4, the inference unit 104 includes an obtainment unit 410, a convolutional computation unit 430, a padding unit 440, an output unit 450, and the like. The obtainment unit 410 includes a data division unit 411. These functional units are implemented with the CPU 101 executing the program held in the ROM 102, for example.

The ROM 102 holds in advance the division condition of the target data, the reference data obtainment condition, the padding condition, and the filter coefficient obtained by the inference unit 104. The division condition is a division position 401 and a division size 402 illustrated in FIG. 4. The reference data obtainment condition is a reference data position 403 illustrated in FIG. 4. The padding condition is a padding method 405 and a padding position 406 illustrated in FIG. 4. A filter coefficient 404 is the filter coefficients learned by an external learning apparatus that include the multiple filter coefficients used in all the layers of the inference unit 104.

The division position 401 is information indicating a position of the image block in the original image in a case where the original image is divided into the image block. In a case of the image data, the position is designated by coordinates in the original image, for example. The division size 402 is information indicating the size of the image block. In a case of the image data, a vertical size and a horizontal size are designated. Although the division size 402 is arbitrary, it is preferred to determine the division size 402 according to the capacity of the memory (the SRAM 310) included in the inference unit 104. Additionally, the minimum size of the division size 402 is determined depending on a structure of the CNN constructed in the inference unit 104. A factor to determine the structure of the CNN is the filter size in the layer, the number of layers, the number of times of contraction and expansion, and the like.

The reference data position 403 is information to specify a position (a pixel) in the original image from which the obtainment unit 410 obtains the reference data, and the position and a data obtainment range with respect to target data 421 are determined. Specifically, for example, information indicating that the data is obtained from one line on the right and left, one line on the top and bottom, or one line on the right, left, top, and bottom for every other pixel is set.

The padding method 405 is information indicating a method of padding the deficient computation data with data, which is set as fixed value padding, mirror image padding, average value padding, and the like, for example. The fixed value padding is a method of padding with “O” and another arbitrary real value. The mirror image padding is a method of inversely arranging the data in the image block to be line-symmetrical at an end portion of the image block as a boundary line. The average value padding is a method of padding with an average value of peripheral pixel values. Note that, the padding method is not limited to the above-described example and another method may be applicable. In the following description, data applied by the padding unit 440 is referred to as padding data.

The padding position 406 is information to specify a position in which the padding unit 440 pads the data, and the position and the range with respect to the target data 421 are determined, for example. In the present embodiment, data except the reference data that is a part of the margin data required for the convolutional computation of the target data 421 is padded. Therefore, the information of the padding position 406 is the data obtained from the margin data for the target data 421 except the reference data. Specifically, for example, in a case where the margin data is a range of one line on the right, left, top, and bottom and “one line on the right and left” is set as the reference data position 403, the information of the padding position 406 is “one line on the top and bottom”. Additionally, in a case where “one line on the top and bottom” is set as the reference data position 403, the information of the padding position 406 is “one line on the right and left”. Moreover, in a case where “data of one line on the right, left, top, and bottom for every other pixel (reference data obtainment)” is set as the reference data position 403, the information of the padding position 406 is “data of one line on the right, left, top, and bottom that is a pixel in which no reference data is arranged”. Note that, the above-described information indicating the division condition, the reference data obtainment condition, and the padding condition is an example, and another content may be applicable. Additionally, although an example in which the CPU 101 reads out the division condition, the reference data obtainment condition, and the padding condition held in the ROM 102 and sets the conditions to the inference unit 104 is described, it is not limited to this method, and the data obtainment and the padding may be performed so as to satisfy the above-described condition by the program.

The image data 400 (the original image) in the page unit that is held in the DRAM 103 is read into the inference unit 104 by the obtainment unit 410. Preferably, the obtainment unit 410 reads the image data 400 held in the DRAM 103 after dividing the image data 400 into the image block in a predetermined size by the data division unit 411. Information of a division position in the original image data 400 of the image block and information of the division size are set in advance in the ROM 102 as the division position 401 and the division size 402. Note that, although FIG. 4 is a diagram assuming that the image data 400 is divided in a case where the inference unit 104 reads the image data from the DRAM 103, it is not limited thereto, and the data of the image block divided in advance by preprocessing may be held in the DRAM 103. Additionally, the image block may be held in the DRAM 103 with the reference data added thereto.

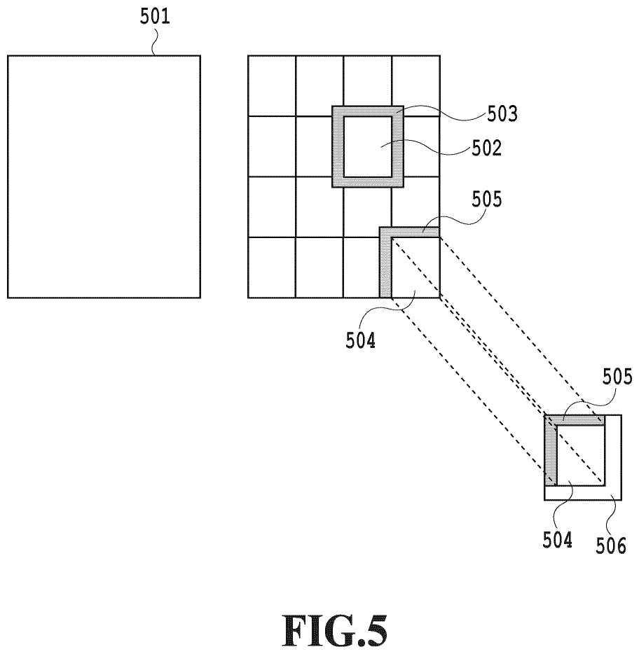

FIG. 5 is a diagram describing the data for inference and a data group existing around the divided image block. In the example illustrated in FIG. 5, the image data of one page that is the data for inference is divided into quarters vertically and horizontally, and an example in which the image data is divided into 16 blocks in total is illustrated. In the following description, the image data before the division is referred to as an original image 501, and the image data of one block after the division is referred to as image blocks 502 and 504.

The obtainment unit 410 reads the image blocks divided by the data division unit 411 as the target data 421 sequentially in the order of processing and deploys the image blocks to the input data region 311 of the SRAM 310. In this process, the obtainment unit 410 also obtains the information of the division position 401. This is because an obtainment position of the reference data may be changed depending on the division position. In the present embodiment, the target data 421 of the divided one image block is deployed to the input data region 311. Additionally, the obtainment unit 410 obtains reference data 422 from a pixel group existing separately from the target data 421 around the obtained image block (the target data 421) and deploys the reference data 422 to the input data region 311 of the SRAM 310.

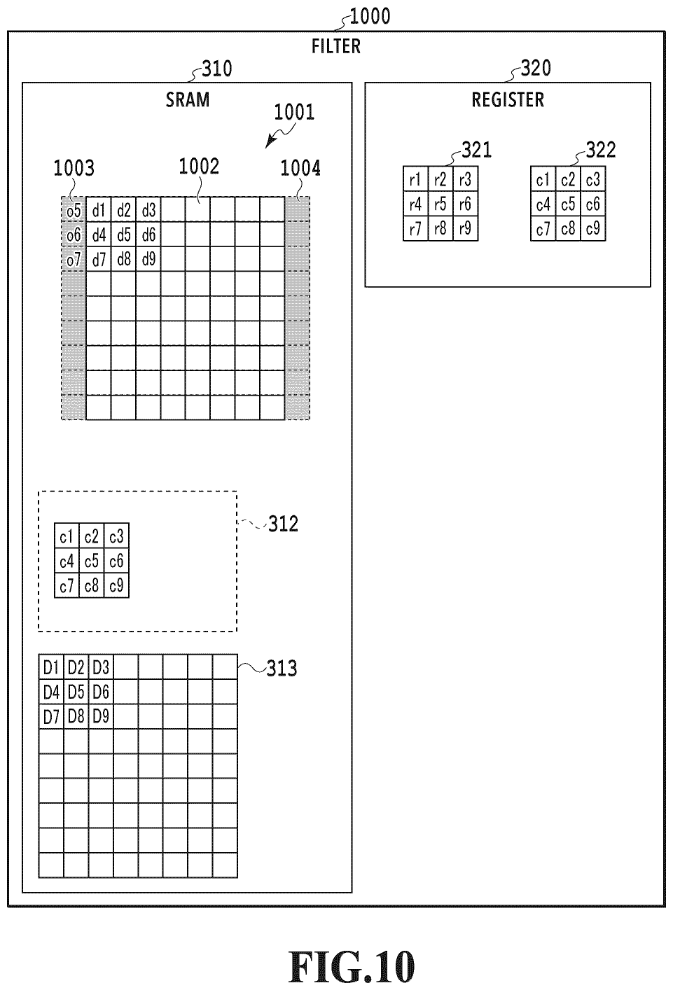

The reference data 422 is the margin data required to obtain the computation result data in a predetermined size in the convolutional computation executed by the convolutional computation unit 430. In the present embodiment, a part of the margin data is obtained as the reference data 422 (regions 1003 and 1004 in FIG. 10). Based on the information of the reference data position 403 set in the ROM 102 and the information of the division position 401 and division size 402 of the obtained target data 421, the obtainment unit 410 can specify the position in the original image from which the reference data is to be obtained. The obtainment unit 410 obtains the reference data 422 from the data group existing around the obtained target data 421, that is, the original image 501 held in the DRAM 103, and deploys the reference data 422 to the input data region 311. Other data except the reference data 422 out of the margin data is padded by the padding, for example.

The size of the margin data required for the convolutional computation is determined depending on a structure of a CNN model constructed in the inference unit 104. For example, in a case of a 3×3 filter, a range of one line (one column or one row) each on the right, left, top, and bottom around the target data 421 is used as the margin data for the computation. In a case of a 5×5 filter, a range of two lines (two columns or two rows) each on the right, left, top, and bottom around the target data 421 is used as the margin data for the computation.

As illustrated in FIG. 5, the data group in a range positioned around the image block 502 and shown in gray is margin data 503 required for the convolutional computation. The margin data 503 of the image block 502 is data overlapping with the adjacent image block. In the present embodiment, in order to reduce the SRAM capacity and suppress decline in reliability of the computation result, the obtainment unit 410 obtains only a part of the margin data 503, which is data on the right and left of the target data out of the margin data 503, for example, as the reference data 422 from the DRAM 103. The other data except the reference data 422 out of the margin data 503 is padded with the fixed value such as “0” by the padding unit 440, for example.

Additionally, as can be seen from the image block 504 in FIG. 5, the margin data of the image block 504 positioned at an end portion of the original image 501 is insufficient because there is only data 505 overlapping with the adjacent image block. In this case too, data for a deficient portion 506 may be padded by the padding unit 440.

The obtainment unit 410 obtains the filter coefficient 404 from the ROM 102. For example, in a case where the processing layer is formed of n filters, the obtainment unit 410 obtains filter coefficients corresponding to the n filters and holds the filter coefficients in the filter coefficient region 312 of the SRAM 310.

The convolutional computation unit 430 executes the convolutional computation by using the image block (the target data 421) and the margin data including the reference data 422 around the image block obtained by the obtainment unit 410. In the following description, the target data 421 and the reference data 422 obtained by the obtainment unit 410 from the DRAM 103 is called input data 420. This input data 420 is deployed to the input data region 311 of the SRAM 310. Data that is the input data 420 including the padding data is the computation data processed in the convolutional computation.

The convolutional computation unit 430 reads out the filter coefficients of the processing target layers from the filter coefficient region 312 of the SRAM 310 and sets the filter coefficients to the coefficient register 322 of a register 320. Additionally, the convolutional computation unit 430 sets data of a predetermined computation range from the computation data including the input data 420 and the padding data to the computation register 321 and executes sum-of-products computation of the filter coefficients set to the coefficient register 322. The convolutional computation unit 430 executes the computation of all the pixels of the computation data while sliding the computation range and writes the computation result into the output data region 313 of the SRAM 310. Details of the convolutional computation are described later.

In a case where not all the margin data required for the convolutional computation by the convolutional computation unit 430 is deployed to the input data region 311 (in a case where the obtainment unit 410 does not obtain all the margin data), the padding unit 440 pads the margin with data to fill the deficiency. For example, in a case where information indicating obtainment of the data of one line on the right and left of the target data 421 as the reference data position 403 is set, the obtainment unit 410 obtains only the data of the one line on the right and left of the target data 421 from the DRAM 103 as the reference data 422. The padding unit 440 pads a portion except the reference data 422 out of the margin data with data based on the information of the padding method 405 and the padding position 406 set in advance in the ROM 102.

Additionally, as the image block 504 in FIG. 5, as for the target data 421 in which no pixel as the original image margin data exists, the obtainment unit 410 cannot obtain a part of the margin data. In this case too, the padding unit 440 performs the padding to address the data deficiency for the computation.

As described above, in a case where the computation data processed by the convolutional computation unit 430 is deficient, the padding unit 440 applies the padding data to the deficient data position. In the present embodiment, in order to reduce the capacity of the SRAM 310 as a main object, the padding is performed without obtaining a part of the margin data that can be obtained from the DRAM 103. That is, for a part of the margin data, real data of the original image held in the DRAM 103 is referred, and for the other portions, the padding data is applied. With use of the real data for a part of the margin data included in the computation data as described above, decline in accuracy of the computation result by the CNN is suppressed, and decline in reliability is suppressed. Additionally, with use of the padding data for a part of the margin data, the data amount held in the SRAM 310 is reduced, and the required SRAM capacity is also reduced. Therefore, even in a case of embedded equipment having a restriction in the hardware resource like the printer 100 described in the present embodiment, it is possible to execute the inference using the CNN model while suppressing decline in reliability.

Note that, the layer that partially obtains the margin data as described above may be all the layers forming the CNN or may be at least one layer. Additionally, such a layer may be each included as at least one of all the layers. For example, preferably, the margin data may be partially obtained in the last layer of the input layer (the encoder unit 201) of the CNN.

Additionally, in a case where the target data 421 is divided data, preferably, the position of the reference data in the margin data (the position to which the padding unit 440 applies the padding data) is changed for each position of the target data 421 (the image block). Specifically, in order to prevent the periodicity of the padding positions of the image blocks, preferably, the padding position is set randomly, for example. Thus, it is possible to prevent a portion with decline in reliability from periodically appearing and becoming conspicuous in the output image obtained as a result of the convolutional computation.

The output unit 450 holds the computation result by the convolutional computation unit 430 in the output data region 313 of the SRAM 310. The output unit 450 determines a feature amount vector 460 from results of all the filtering processing and outputs the feature amount vector 460 as an inference result of the inference unit 104.

### Inference

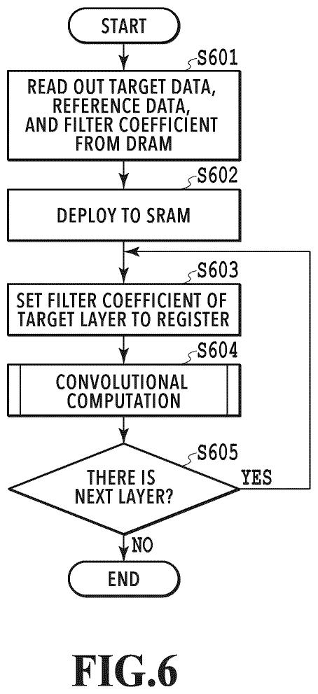

Next, a flow of the inference is described. FIG. 6 is a flowchart illustrating a flow of the inference in the present embodiment. The processing illustrated in the present flowchart is described in the program held in the ROM 102. The program is called by the CPU 101, deployed to a working area of the RAM 103, and executed by the CPU 101. Once the original image as the processing target is transferred to the DRAM 103 via the data transfer I/F 105, the CPU 101 starts the processing illustrated in FIG. 6. In the following description, a sign “S” represents a step.

In S601, the obtainment unit 410 obtains the input data 420 from the DRAM 103 according to the division condition and the reference data obtainment condition held in advance in the ROM 102. The division condition is the division position 401 and the division size 402. The reference data obtainment condition is the reference data position 403. The padding condition is the padding method 405 and the padding position 406. As described above, the input data 420 includes the target data 421 of one image block and the reference data 422, which is a part of the margin data required for the convolutional computation of the corresponding target data 421. Additionally, the obtainment unit 410 obtains the filter coefficient held in advance in the ROM 102. In a case where there are multiple layers processed in the filter 300, multiple filter coefficients are obtained. The obtainment unit 410 deploys the received one or more filter coefficients to the filter coefficient region 312 of the SRAM 310.

In S602, the obtainment unit 410 deploys the obtained input data 420 to the input data region 311 of the SRAM 310 of the filter 300.

In S603, the obtainment unit 410 sets the filter coefficient of the target layer out of the one or more filter coefficients deployed to the SRAM 310 to the coefficient register 322. First, the filter coefficient of a first layer filter is set to the coefficient register 322.

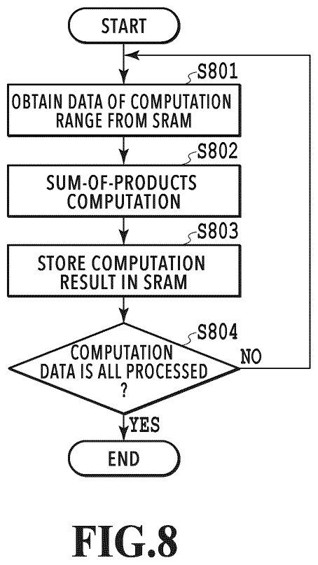

In S604, the convolutional computation unit 430 executes the convolutional computation for the input data 420 deployed to the input data region 311 by using the filter coefficient set to the coefficient register 322. Details of the convolutional computation are described later (FIG. 8).

In S605, the inference unit 104 determines whether the processing of a next layer remains. If the processing of the next layer remains, the process returns to S603. Then, the filter coefficient of a second layer filter is obtained from the SRAM 310 and set to the coefficient register 322, and the convolutional computation of the second layer filter is executed for the input data 420 deployed to the input data region 311. Thus, the convolutional computation of all the first layer filter to n-th layer filter is executed, and in a case where it is determined in S605 that no next layer remains, the processing in the present flowchart ends.

### Example of Obtaining Margin Data; Comparative Example

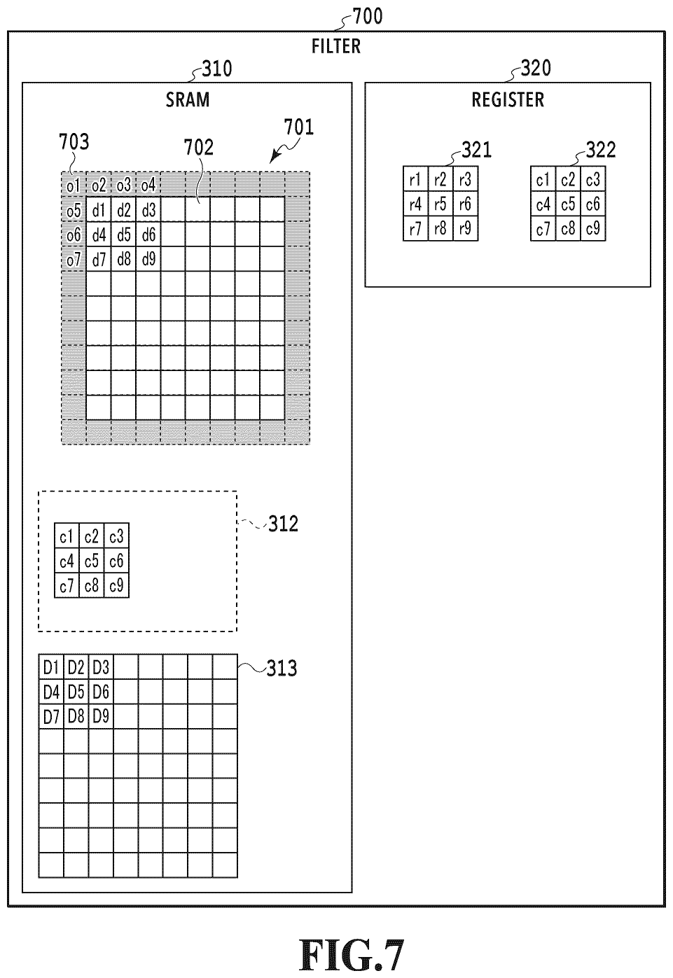

Next, a method of obtaining the margin data is described. First, a method of obtaining the margin data that is a comparative example of the present embodiment is described. FIG. 7 is a diagram illustrating a data obtainment method as the comparative example. FIG. 7 illustrates an example in which the margin data is all obtained from the original image 501 in the DRAM 103.

In FIG. 7, a region 702 shown with a solid line in an input data region 701 in the SRAM 310 is a region to which the target data 421 (the image block after the division) obtained by the obtainment unit 410 from the original image held in the DRAM 103 is deployed. Additionally, a range 703 shown with a broken line and existing around the region 702 shown with a solid line represents a range of the margin data required for the convolutional computation. In the example illustrated in FIG. 7, the entire range of one line of the outer periphery of the target data 421 is obtained from the original image in the DRAM 103 as the margin data (data shown in gray in FIG. 7) and held in the SRAM 310.

In a case where the margin data of the target data 421 is all formed of the real data as described above, the used amount of the SRAM 310 is an amount including not only the target data 421 but all the margin data. Therefore, a large amount of capacity is required. Instead, since the real data is used for the computation, the accuracy of the feature amount vector obtained as a result of the inference is enhanced. In the example in FIG. 7, the range of the margin data is one line each on the right, left, top, and bottom, and this is because the filter size used for the convolutional computation is 3×3. The greater the filter size, the greater the required range 703 of the margin data. In a case where the filter size is 5×5 size, the range 703 of the margin data is two lines each on the right, left, top, and bottom.

### (Convolutional Computation Processing; Comparative Example)

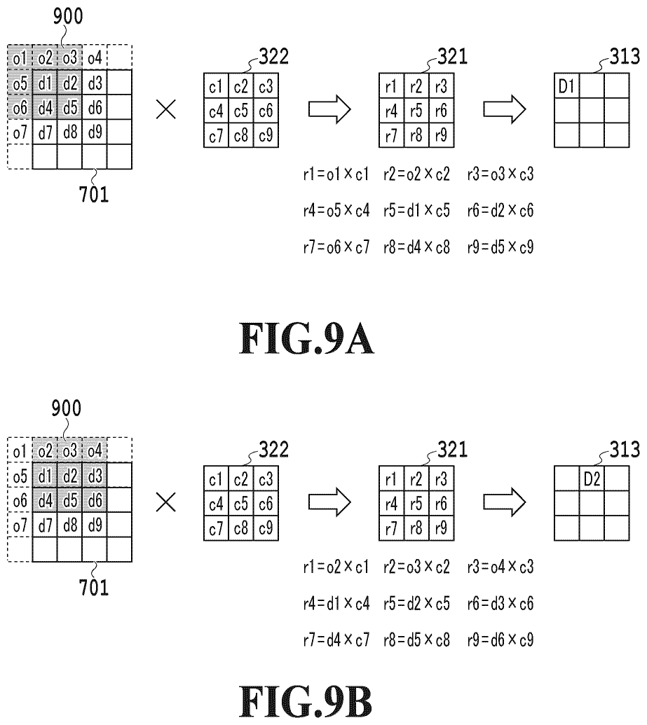

Details of the convolutional computation processing are described with reference to FIGS. 8, 9A and 9B. FIG. 8 is a flowchart describing a flow of the convolutional computation processing in a case of FIG. 7. The processing illustrated in the present flowchart is executed in S604 in FIG. 6. Before the flowchart illustrated in FIG. 8 is started, it is assumed that the input data 420 is deployed to the SRAM 310 as illustrated in FIG. 7 and the filter coefficient is set to the coefficient register 322 by the processing in S601 to S603 in FIG. 6. FIGS. 9A and 9B are diagrams describing an example of the convolutional computation in a case where the margin data is all obtained from the original image as illustrated in FIG. 7.

In S801, the convolutional computation unit 430 obtains the data of the computation range by each range from the input data deployed to the SRAM 310 and sets the data to the computation register 321. The data of the computation range is data of the number of elements of the filter coefficients (3×3). For example, as illustrated in FIG. 9A, in order to obtain a value of a pixel D1 of the output image (the output data region 313), data of a computation range 900 shown in gray in FIGS. 9A and 9B out of the data deployed to the input data region 701 of the SRAM 310 is required. The computation range 900 in FIG. 9A includes nine pixels, which are o1, o2, o3, o5, d1, d2, o6, d4, and d5. In this computation range 900, data of the d1, d2, d4, and d5 is data of the image block (the target data 421) read from the DRAM 103, and data of the o1 to o6 is the real data read from the DRAM 103 as the margin data (the reference data 422).

In S802, the convolutional computation unit 430 executes sum-of-products computation of the data of the obtained computation range 900 and the filter coefficient. The convolutional computation unit 430 multiplies the values of the pixels o1, o2, o3, o5, d1, d2, o6, d4, and d5 of the computation range 900 by corresponding values of the elements c1 to c9 of the filter and writes the multiplication result in pixels r1 to r9 of the computation register 321. Thereafter, the convolutional computation unit 430 collects the multiplication results r1 to r9 of the number of the filter elements held in the computation register 321 and aggregates the results in the pixel r5.

The pixel r5 in the computation range 900 corresponds to the pixel D1 of the output data region 313 (the output image). Therefore, the value of the pixel D1 is determined by the following expression:

$$D 1 = o 1 \times c 1 + o 2 \times c 2 + o 3 \times c 3 + o 5 \times c 4 + d 1 \times c 5 + d 2 \times c 6 + o 6 \times c 7 + d 4 \times c 8 + d 5 \times c 9.$$

In S803, the convolutional computation unit 430 stores the value of the result of the sum-of-products computation in a corresponding pixel position in the output data region 313 of the SRAM 310. In the example in FIG. 9A, the value of the result of the sum-of-products computation is held in the pixel D1 in the output data region 313.

In S804, the convolutional computation unit 430 determines whether the computation data including the target data 421 and the margin data thereof held in the input data region 701 of the SRAM 310 is all processed. If there is the computation data not processed yet, the process returns to S801, and the convolutional computation unit 430 executes the sum-of-products computation for the next computation range. Specifically, as illustrated in FIG. 9B, the convolutional computation unit 430 slides the computation range 900 horizontally by one line. That is, out of the computation data obtained from the SRAM 310, the values of o1, o5, and o6 are discarded, the values of 04, d3, and d6 are taken into the computation register 321 instead, and the above-described sum-of-products computation is executed.

A value of a pixel D2 of the output data region 313 (the output image) is determined by the following expression:

$$D 2 = o 2 \times c 1 + o 3 \times c 2 + o 4 \times c 3 + d 1 \times c 4 + d 2 \times c 5 + d 3 \times c 6 + d 4 \times c 7 + d 5 \times c 8 + d 6 \times c 9.$$

The determined value is written in the pixel D2 in the output data region 313.

Thus, the convolutional computation unit 430 repeatedly executes the sum-of-products computation with the filter coefficient while sliding the computation range sequentially, and once the computation data including the target data 421 and the margin data thereof held in the SRAM 310 is all processed, the processing in the present flowchart ends. Once the processing in FIG. 8 ends, the computation result data after the filtering processing of the target layer is held in the output data region 313 of the SRAM 310.

Note that, in the example in FIGS. 7 to 9A and 9B, since the convolutional computation with the filter coefficients of 3×3 is performed, the computation range 900 is a range of 3×3. The results of the convolutional computation are aggregated in the central pixel of the computation range as expressed by the following expression (1). In the expression (1), j is a number indicating the pixel position an output image D, ci is a value of each element of the filter coefficient, and di is a value of the computation data included in the computation range. Additionally, i is an identifier indicating the pixel position in the filter coefficient or the computation range. A computation result Dj of the expression (1) is a value of the pixel positioned in the center of the computation range 900.

$$Dj = \sum ci \times di \qquad ( 1 )$$

As described above, the convolutional computation requires the margin data of a range according to the filter size. In addition, the margin data of a greater range is required according to the number of layers of the filter. In other words, the range of the margin data required to obtain the output image in a predetermined size eventually is determined by the structure of the CNN at least including the filter size and the filter layer number (the number of convolutional layers).

### (Method of Obtaining Margin Data and Convolutional Computation Processing According to Present Embodiment)

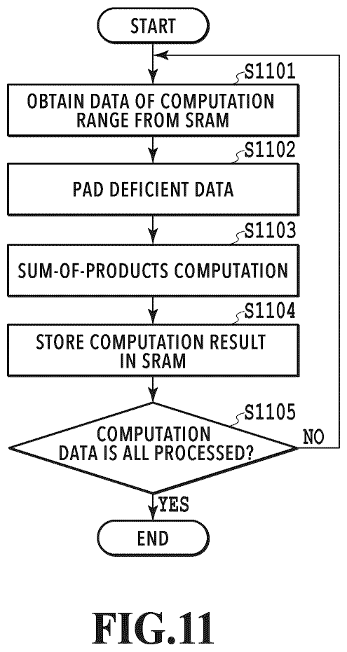

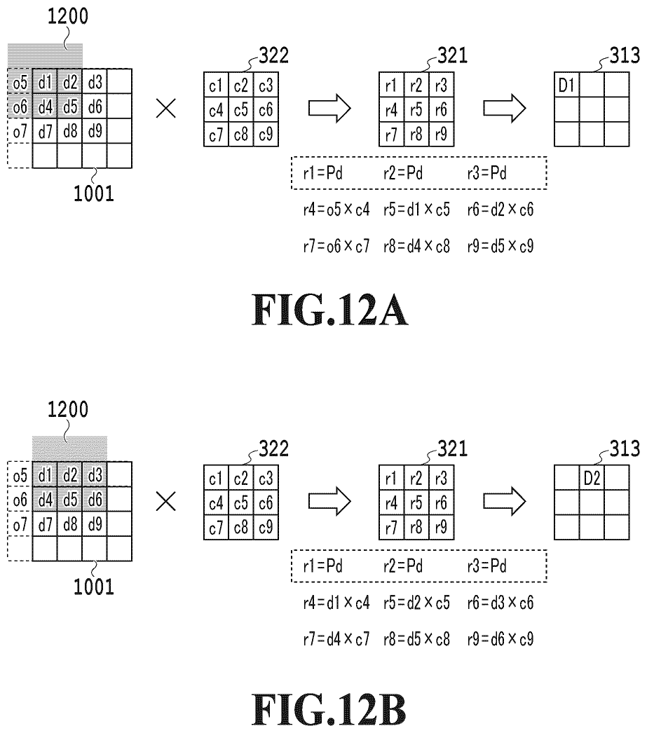

Next, a method of obtaining the margin data and the convolutional computation processing in the present embodiment are described with reference to FIGS. 10 to 12. FIGS. 10A and 10B is a diagram illustrating a method of obtaining peripheral data according to the present embodiment. FIG. 11 is a flowchart describing a flow of the convolutional computation processing in a case of FIG. 10. FIGS. 12A and 12B are diagrams describing a calculation procedure of the convolutional computation in a case of FIG. 10.

In FIG. 10, a region 1002 shown with a solid line in an input data region 1001 in the SRAM 310 is a region to which the target data 421 (the divided image block) obtained by the obtainment unit 410 from the original image held in the DRAM 103 is deployed. Additionally, regions 1003 and 1004 (regions shown in gray in FIG. 10) shown with a broken line and existing on the right and left of the region 1002 represents a region held in the reference data 422. That is, in the example illustrated in FIG. 10, out of the margin data required for the convolutional computation, only the data of the regions on the right and left of the target data 421 is taken from the DRAM 103 as the reference data 422 and deployed to the SRAM 310. The data of the regions on the top and bottom of the target data 421 is not taken. Alternatively, the data is deleted after being taken. Thus, the inference unit 104 of the present embodiment partially obtains the margin data required for the convolutional computation from the DRAM 103 and deploys the margin data to the SRAM 310. In a case in FIG. 10, comparing with a case in FIG. 7, the used amount of the SRAM 310 is reduced by one line each on the top and bottom.

In a case of the first layer filter of 3×3, the margin data required for the convolutional computation is one line each on the right, left, top, and bottom; however, according to the data obtainment method of the present embodiment illustrated in FIG. 10, the margin data of one line each on the top and bottom is not deployed to the SRAM 310. The margin data deficient in this case is interpolated by the padding. As the filter size is greater, the required width (range) of the margin data is also increased, and in a case where more layers are included, the margin data of a further greater width is required. Therefore, in a case where the filter size and the number of the layers are increased, a greater memory reduction effect is exerted.

The convolutional computation processing using the data obtained by the method illustrated in FIG. 10 is specifically described with reference to FIGS. 11,12A and 12B. The processing illustrated in the present flowchart is executed in S604 in FIG. 6. Before the flowchart illustrated in FIG. 11 is started, it is assumed that the SRAM 310 holds the input data as illustrated in FIG. 10 and the filter coefficient is set to the coefficient register 322 by the processing in S601 to S603 in FIG. 6. As the input data, the divided image block (the target data 421) and the reference data 422 of the regions on the right and left of the divided image block are taken. Note that, although the identifiers d1 to d9 and 05 to o7 identifying the pixels are illustrated in only some pixels in FIG. 10, this is for the description of the computation range in FIGS. 12A and 12B. In reality, the data is taken in all the pixels in the input data region 1001.

In S1101, the convolutional computation unit 430 obtains the data of the computation range by each range from the input data deployed to the SRAM 310 and sets the data to the computation register 321. The data of the computation range is data of the number of elements of the filter coefficients (3×3). For example, as illustrated in FIG. 12A, in order to obtain the value of the pixel D1 of the output image (the output data region 313), data of a computation range 1200 shown in gray in FIGS. 12A and 12B out of the computation data deployed to the input data region 1001 of the SRAM 310 is required. However, in a case where the data is taken by the method illustrated in FIG. 10, the data of o5, d1, d2, o6, d4, and d5 in the computation range 1200 is held in the SRAM 310, and the data of three pixels above o5, d1, and d2 is not held in the SRAM 310. Note that, the data of d1, d2, d4, and d5 in the computation range 1200 is data of the image block read from the DRAM 103, and the data of o5 and o6 is the real data read from the DRAM 103 as the reference data 422.

In S1102, the padding unit 440 applies the padding data to the computation register 321 for the three pixels above o5, d1, and d2 that are deficient in data. Thus, the padding unit 440 directly writes the padding data in the corresponding pixel position of the computation register 321 before the sum-of-products computation. Alternatively, the padding unit 440 may directly write the padding data in the corresponding pixel position of the computation register 321 after the sum-of-products computation. The padding data is a value set by the padding method 405. For example, the padding data may be an arbitrary fixed value such as “0”, mirror image data of the data in the image block, an average value of the real data around the corresponding pixel, or the like.

It is possible to end the padding processing with only the processing in the register 320 by directly writing the padding data into the computation register 321 without deploying to the SRAM 310. In the example illustrated in FIG. 12A, since the data of the three pixels positioned above 05, d1, and d2 in the computation range 1200 is deficient, the padding unit 440 directly writes padding data Pd in corresponding positions r1, r2, and r3 in the computation register 321.

In S1103, the convolutional computation unit 430 executes the sum-of-products computation of the data of the computation range 1200 obtained in S1101 and the filter coefficient. That is, the convolutional computation unit 430 multiplies the values of the pixels o5, d1, d2, o6, d4, and d5 in the computation range 1200 by the values of the corresponding elements c4 to c9 of the filter and writes the results in r4 to r9 of the computation register 321. Thereafter, the convolutional computation unit 430 collects and adds the multiplication results and the padding data of the number of the filter elements held in the registers r1 to r9 and determines the result thereof as the value of the pixel D1.

The value of D1 of the output image is calculated as below:

$$D 1 = Pd + P d + Pd + o 5 \times c 4 + d 1 \times c 5 + d 2 \times c 6 + o 6 \times c 7 + d 4 \times c 8 + d 5 \times c 9.$$

The value of D1 is written in the output data region 313. Note that, this calculation example indicates a case where the padding data Pd is written in r1, r2, and r3 of the computation register 321 as a value after the sum-of-products computation. In a case where the padding data is applied before the sum-of-products computation, the value of D1 of the output image is calculated as below:

$$D 1 = P d \times c 1 + Pd \times c 2 + Pd \times c 3 + o 5 \times c 4 + d 1 \times c 5 + d 2 \times c 6 + o 6 \times c 7 + d 4 \times c 8 + d 5 \times c 9.$$

In S1104, the convolutional computation unit 430 holds the result of the sum-of-products computation in the corresponding pixel position in the output data region 313 of the SRAM 310. In the example in FIG. 12A, the value of the result of the sum-of-products computation is held in the pixel D1 of the output data region 313.

In S1105, the convolutional computation unit 430 determines whether the computation data held in the input data region 311 of the SRAM 310 is all processed. In a case where there is the computation data that is not processed yet, the process returns to S1101, and the convolutional computation unit 430 executes the sum-of-products computation for the next computation range. Specifically, as illustrated in FIG. 12B, the computation range 1200 is moved horizontally by one line. That is, out of the computation data obtained from the SRAM 310, the values of o5 and o6 are discarded, and the values of d3 and d6 are taken into the computation register 321 instead to execute the above-described sum-of-products computation.

Since the data of the three pixels above d1, d2, and d3 in the computation range 1200 is deficient, the padding data Pd is applied to the corresponding positions r1, r2, and r3 in the computation register 321.

The value of the pixel D2 of the output image is determined by the calculation below:

$$D 2 = P d + P d + Pd + d 1 \times c 4 + d 2 \times c 5 + d 3 \times c 6 + d 4 \times c 7 + d 5 \times c 8 + d 6 \times c 9.$$

The value of the pixel D2 is written in the output data region 313. Note that, this calculation example indicates a case where the padding data Pd is written in r1, r2, and r3 in the computation register 321 as a value after the sum-of-products computation. In a case where the padding data is applied before the sum-of-products computation, the value of D2 of the output image is calculated as below:

$$D 2 = P d \times c 1 + Pd \times c 2 + Pd \times c 3 + d 1 \times c 4 + d 2 \times c 5 + d 3 \times c 6 + d 4 \times c 7 + d 5 \times c 8 + d 6 \times c 9.$$

Thus, the convolutional computation unit 430 repeats the convolutional computation while sliding the computation range and padding the deficient data. Once the computation data including the target data 421 and the margin data held in the SRAM 310 is all processed, the processing in the present flowchart ends. Once the processing in FIG. 11 ends, the output image after the filtering processing of the target layer is held in the output data region 313 of the SRAM 310.

As described in the present embodiment, in a case where a reduced portion of the margin data is the lines on the top and bottom of the image block, the sliding direction of the computation range is preferably the horizontal direction. Likewise, in a case where the reduced portion of the margin data is the lines on the right and left of the image block, the sliding direction of the computation range is preferably the vertical direction. That is, preferably, the reference data is obtained for the target data from the data group existing in the same direction as the sliding direction of the computation range of the convolutional computation. This is because it is possible to reduce the number of times of executing the padding since the pixel positions deficient in data are the same before and after the computation range is moved. Note that, it does not mean that the obtainment of the reference data for the target data from the data group existing in a direction orthogonal to the sliding direction of the computation range of the convolutional computation is prevented. That is, in a case where the reduced portion of the margin data is the lines on the top and bottom of the image block, the sliding direction of the computation range may be the vertical direction. Additionally, in a case where the reduced portion of the margin data is the lines on the right and left of the image block, the sliding direction of the computation range may be the horizontal direction.

Additionally, in a case where the arrangement direction of the data in the DRAM 103 is the horizontal direction, the reduced portion of the margin data is preferably the lines on the top and bottom of the image block. This is because it is possible to reduce the frequency of access to the DRAM 103 in a case where the obtainment unit 410 reads the data from the DRAM 103. Note that, the arrangement direction of the data in the DRAM 103 may be the vertical direction. The frequency of access to the DRAM 103 in a case where the obtainment unit 410 reads the data from the DRAM 103 is described below.

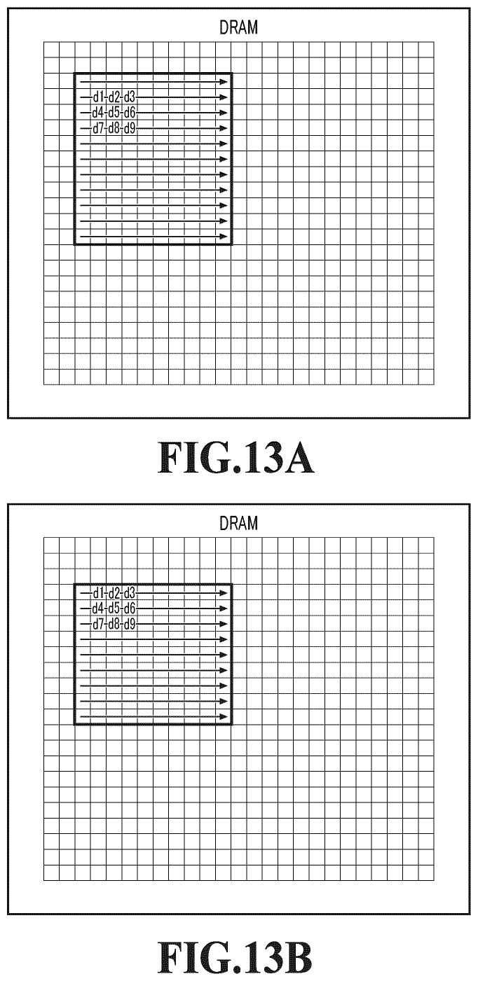

FIGS. 13A and 13B are diagrams describing a method of accessing the DRAM in a case where the data is taken from the DRAM 103 into the SRAM 310. The image data held in the DRAM 103 is illustrated. The obtainment unit 410 obtains image blocks of 10 in width×11 in length indicated by a thick line frame from the DRAM 103 and transfers the image blocks to the SRAM 310. The order of the images in the DRAM 103 is from the left to the right. In a case where the data is transferred from the DRAM 103 to the SRAM 310, the obtainment unit 410 transfers the data for each arrow illustrated in the frame. In the example in FIG. 13A, the obtainment unit 410 accesses the DRAM 103 11 times to transfer the data.

On the other hand, in a case where the margin data on the top and bottom is reduced as described in the present embodiment, image blocks of 10 in width×9 in length as illustrated in FIG. 13B are transferred from the DRAM 103. Therefore, as illustrated in a thick line frame, the number of times of accessing the DRAM 103 is reduced by two, for the top and bottom, and the number of times of the access is nine times. The number of times of the access is less than that in a case in FIG. 13A. Thus, it is possible to reduce the frequency of access to the DRAM 103 according to a relationship between the arrangement of the data on the DRAM 103 and the position of the padding (the position in which the margin data is reduced).

Note that, due to the characteristic of the DRAM 103, the DRAM 103 is configured to read a certain amount of data for each data arrangement. In the example in FIGS. 13A and 13B, the data of sequential 10 pixels are read for one access. Accordingly, for example, in a case where the margin data on the right and left is reduced, although reading of sequential eight pixels is sufficient, the DRAM 103 reads the data of 10 pixels in this system. Therefore, the number of times of the data access to the DRAM 103 is the same as that in a case where the margin data is all obtained, which is 11 times (corresponding to the 11 arrows in FIG. 13A). In this case, the excessive read data may be deleted after being obtained.

As described above, the inference unit 104 of the printer 100 in the present embodiment takes a part of the margin data required for the convolutional computation from the original image as the reference data and interpolates the other data except the reference data out of the margin data by the padding. Therefore, it is possible to reduce the memory capacity required for the filtering processing more than that in a case where the margin data is all taken. Additionally, comparing with a case where the margin data is all padded, since it is possible to use the real data for the computation, it is possible to suppress decline in accuracy of the feature amount vector obtained as a result of the filtering processing. Accordingly, it is possible to reduce the storage capacity required for the convolutional computation of the CNN while suppressing decline in reliability of the computation result.

Note that, although an example in which the top and bottom regions are not obtained but the right and left regions are obtained as the reference data out of the margin data of the target data is described in the above-described example, the present disclosure is not limited to this example. The margin data of only either of the top and bottom lines or only either of the left and right lines may be reduced. Additionally, a ratio of the reference data to the entire amount of the margin data required for the convolutional computation is arbitrary. A modification of the first embodiment is described below.

### Modification 1

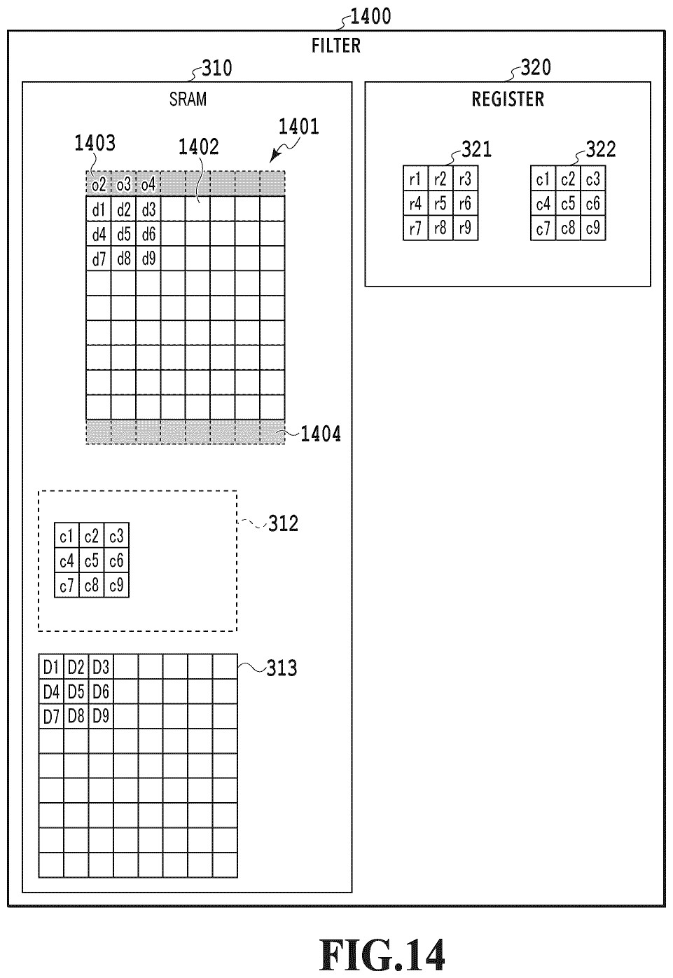

FIG. 14 is a diagram illustrating a data obtainment method according to a modification 1 of the present embodiment. In the example illustrated in FIG. 14, the margin data taken from the DRAM 103 into the SRAM 310 is reduced more than that in a case in FIG. 7. A different point from the first embodiment illustrated in FIG. 10 is that the reference data is obtained from the margin data, which is required for the convolutional computation, of one line each on the top and bottom but the margin data on the right and left is not obtained. Regions 1403 and 1404 shown in gray in FIG. 14 indicate a region holding the reference data taken from the DRAM 103.

In FIG. 14, a region 1402 shown with a solid line in an input data region 1401 in the SRAM 310 is a region to which the image block (the target data 421) obtained from the DRAM 103 is deployed. Additionally, the regions 1403 and 1404 shown with a broken line and existing on the top and bottom of the region 1402 shown with a solid line mean the region holding the reference data 422 taken from the DRAM 103. In the example illustrated in FIG. 14, only the data of the top and bottom regions of the image block out of the margin data required for the convolutional computation is taken from the DRAM 103 and deployed to the SRAM 310. The data of the right and left regions is not taken. Alternatively, the data is deleted after being taken. In the example illustrated in FIG. 14 too, the margin data required for the convolutional computation is obtained partially from the DRAM 103 and deployed to the SRAM 310, and thus the used amount of the SRAM 310 is reduced more than that in FIG. 7.

In a case in FIG. 14 too, the deficient data in the margin data required for the convolutional computation is padded by the padding unit 440. The padding unit 440 may write the padding data directly in the corresponding data region in the computation register 321. As described above, the padding data may be an arbitrary fixed value such as “0”, mirror image data of the data in the image block, an average value of the data around the corresponding pixel, and the like, for example. A processing procedure of the convolutional computation is similar to that in the above-described embodiment.

As illustrated in FIG. 14, in a case where the data on the right and left is padded, the sliding direction of the computation range is preferably the vertical direction. Additionally, in terms of the efficiency of the frequency of access to the DRAM 103, it is preferable in a case where the data arrangement on the DRAM 103 is in the vertical direction.

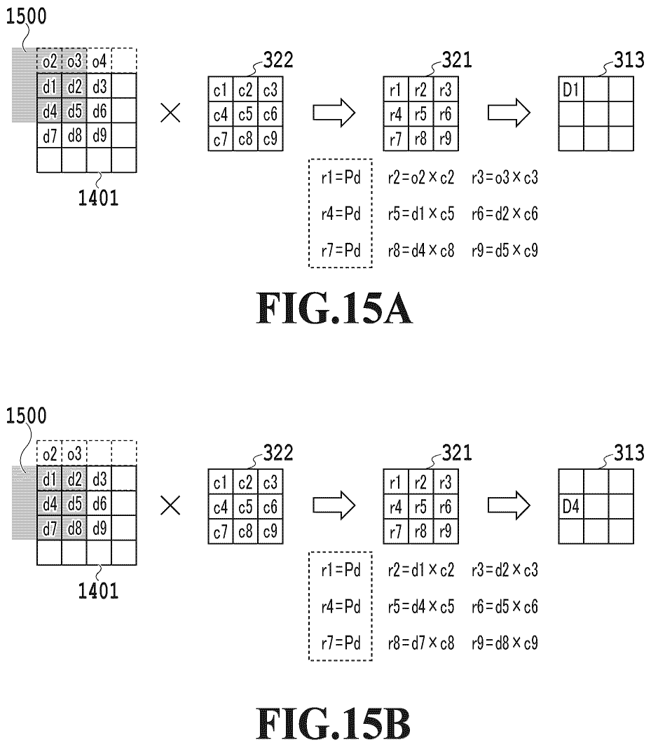

FIGS. 15A and 15B are diagrams describing the calculation procedure of the convolutional computation using the computation data taken into the SRAM 310 by the method illustrated in FIG. 14. An example of a case where a sliding direction of a computation range 1500 is the vertical direction is described. As illustrated in FIG. 15A, in order to obtain the value of the pixel D1 in the output data region 313 (the output image), data of the computation range 1500 shown in gray in FIG. 15A out of the input data deployed to the input data region 1401 of the SRAM 310 is required. In the computation range 1500, the data of o2, o3, d1, d2, d4, and d5 is held in the SRAM 310, but the data of three pixels on the left of o2, d1, and d4 is not held in the SRAM 310. Note that, in the computation range 1500, the data of d1, d2, d4, and d5 is data of the image blocks read from the DRAM 103, and the data of o2 and o3 is data read from the DRAM 103 as the reference data.

The padding unit 440 applies the padding data to the pixel position deficient in data. The padding unit 440 may directly write the padding data in the corresponding data region in the computation register 321. As described above, the padding data may be an arbitrary fixed value such as “0”, mirror image data of the data in the image block, an average value of the data around the corresponding pixel, and the like, for example. In the example illustrated in FIG. 15A, since the data of the three pixels positioned on the left of o2, d1, and d4 in the computation range 1500 is deficient, the padding unit 440 directly writes the padding data Pd in corresponding positions r1, r4, and r7 of the computation register 321.

The convolutional computation unit 430 executes the sum-of-products computation of the data of the computation range 1500 and the filter coefficient. That is, the convolutional computation unit 430 multiplies the values of the pixels o2, o3, d1, d2, d4, and d5 of the computation range 1500 by the values of the corresponding elements c2, c3, c5, c6, c8, and c9 of the filter and writes the results in r2, r3, r5, r6, r8, and r9 of the computation register 321. Thereafter, the convolutional computation unit 430 collects and adds the multiplication results and the padding data of the number of the filter elements held in the registers r1 to r9 and determines the result thereof as the value of the pixel D1.

The value of D1 of the output image is calculated as below:

$$D 1 = Pd + o 2 \times c 2 + o 3 \times c 3 + Pd + d 1 \times c 5 + d 2 \times c 6 + Pd + d 4 \times c 8 + d 5 \times c 9.$$

The value of D1 is written in the output data region 313. Note that, this calculation example indicates a case where the padding data Pd is written in r1, r4, and r7 of the computation register 321 as a value after the sum-of-products computation. In a case where the padding data is applied before the sum-of-products computation, the value of D1 of the output image is calculated as below:

$$D 1 = P d \times c 1 + o 2 \times c 2 + o 3 \times c 3 + Pd \times c 4 + d 1 \times c 5 + d 2 \times c 6 + Pd \times c 7 + d 4 \times c 8 + d 5 \times c 9.$$

Next, as illustrated in FIG. 15B, the convolutional computation unit 430 slides the computation range 1500 downward (in the vertical direction) by one line. That is, out of the computation data obtained from the SRAM 310, the values of o2 and o3 are discarded, and the values of d7 and d8 are taken instead. Since the data of the three pixels positioned on the left of d1, d4, and d7 in the computation range 1500 is deficient, the padding data Pd is applied to the corresponding positions r1, r4, and r7 of the register. Note that, this padding data is already written. In this case, it is unnecessary to write the padding data Pd again.

The convolutional computation unit 430 executes the sum-of-products computation of the obtained data of the computation range 1500 and filter coefficient and determines a value of a pixel D4.

The value of D4 of the output image is calculated as below:

$$D 4 = P d + d 1 \times c 2 + d 2 \times c 3 + Pd + d 4 \times c 5 + d 5 \times c 6 + Pd + d 7 \times c 8 + d 8 \times c 9.$$

The value of D4 is written in the output data region 313. Note that, this calculation example indicates a case where the padding data Pd is written in r1, r4, and r7 of the computation register 321 as a value after the sum-of-products computation. In a case where the padding data is applied before the sum-of-products computation, the value of D4 of the output image is calculated as below:

$$D 4 = P d \times c 1 + d 1 \times c 2 + d 2 \times c 3 + Pd \times c 4 + d 4 \times c 5 + d 5 \times c 6 + Pd \times c 7 + d 7 \times c 8 + d 8 \times c 9.$$

As described in the modification 1, in a case where the reduced portion of the margin data is the regions on the right and left of the image block, the sliding direction of the computation range is preferably the vertical direction. This is because it is possible to reduce the number of times of applying the padding data since the pixel positions deficient in data are the same before and after the computation range is moved. Additionally, in a case where the arrangement direction of the data of the DRAM 103 is the vertical direction, if the portion from which the margin data is reduced is the regions on the right and left of the image block as described in the modification 1, it is possible to suppress the frequency of access to the DRAM 103, which is efficient. Note that, in the above-described example, the sliding direction of the computation range may be the horizontal direction. Additionally, the arrangement direction of the data of the DRAM 103 may be the horizontal direction. Moreover, only the line on the top or only the line on the bottom may be obtained as the reference data.

As described above, according to the modification 1, the data on the top and bottom that is a part of the margin data required for the convolutional computation is taken from the original image as the reference data, and the other data except the reference data out of the margin data is interpolated by the padding. Therefore, it is possible to reduce the memory capacity required for the filtering processing more than that in a case where the margin data is all taken. Additionally, comparing with a case where the margin data is all padded, since it is possible to use the real data for the computation, it is possible to suppress decline in accuracy of the feature amount vector obtained as a result of the filtering processing. Accordingly, it is possible to reduce the storage capacity required for the convolutional computation of the CNN while suppressing decline in reliability of the computation result.

### Modification 2

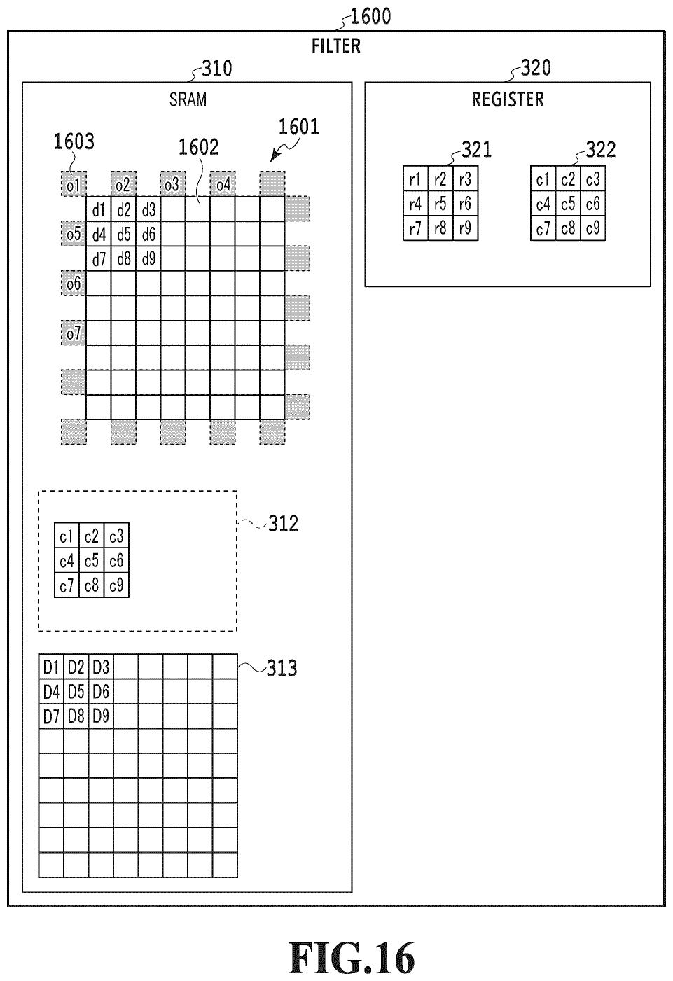

FIG. 16 is a diagram illustrating a data obtainment method according to a modification 2 of the present embodiment. In the example illustrated in FIG. 16, the margin data taken from the DRAM 103 into the SRAM 310 is reduced more than that in a case in FIG. 7. A different point from the first embodiment (FIG. 10) is that the reference data is obtained discretely in the regions on the right, left, top, and bottom that are the margin data required for the convolutional computation. Multiple pixels 1603 shown in gray in FIG. 16 indicate the region holding the reference data taken from the DRAM 103.

In FIG. 16, a region 1602 shown with a solid line in an input data region 1601 in the SRAM 310 is a region to which the image block obtained from the DRAM 103 is deployed. Additionally, the multiple regions 1603 (the regions shown in gray) shown with a broken line and existing on the right, left, top, and bottom of the region 1602 indicate the region holding the reference data. That is, in the example illustrated in FIG. 16, in addition to the image block, the data of the pixel around the image block is taken from the DRAM 103 every other pixel and deployed to the SRAM 310. In a case in FIG. 16 too, since the margin data required for the convolutional computation is partially obtained from the DRAM 103 and deployed to the SRAM 310, the used amount of the SRAM 310 is reduced more than that in a case in FIG. 7.

In a case in FIG. 16 too, the deficient data in the margin data required for the convolutional computation is padded by the padding unit 440. The padding unit 440 may directly write the padding data in the corresponding data region of the computation register 321. The padding data may be, as described above, an arbitrary fixed value such as “O”, mirror image data of the data in the image block, an average value of the data around the corresponding pixel, and the like, for example. A processing procedure of the convolutional computation is similar to that in the above-described embodiment and modification.

As described above, according to the modification 2, a part of the margin data required for the convolutional computation is taken from the original image as the reference data, and the other data except the reference data out of the margin data is interpolated by the padding. Therefore, it is possible to reduce the memory capacity required for the filtering processing more than that in a case where the margin data is all taken. Additionally, comparing with a case where the margin data is all padded, since it is possible to use the real data for the computation, it is possible to suppress decline in accuracy of the feature amount vector obtained as a result of the filtering processing.

Additionally, according to the modification 2, it is possible to expect further improvement of the accuracy of the feature amount vector obtained as a result of the filtering processing more than a case in FIGS. 10 and 14. This is because, although the data is thinned, the padding data is prevented from locally concentrating, and a true value of the original image is used for the convolutional computation.

Note that, although an example of taking the reference data from every other pixel is described in the example in FIG. 16, it is not limited to this example, and the arrangement may be skipped by the arbitrary number of pixels such as every other two pixels or every other three pixels. Additionally, as long as it is discrete arrangement, any arrangement may be applicable and the reference data may be arranged randomly in arbitrary positions. In addition, as illustrated in FIGS. 10 and 14, in a case where the reference data of at least any one of the lines on the right, left, top, and bottom of the margin data is taken, the reference data may be obtained discretely in the line.

### Modification 3

Although a case where the width of the margin data is one line on the right, left, top, and bottom in the above-described first embodiment and modifications 1 and 2, the present disclosure is also applicable to a case where the margin data spans multiple lines. For example, in a case of using the 5×5 filter, the required width of the margin data is two lines each on the right, left, top, and bottom.

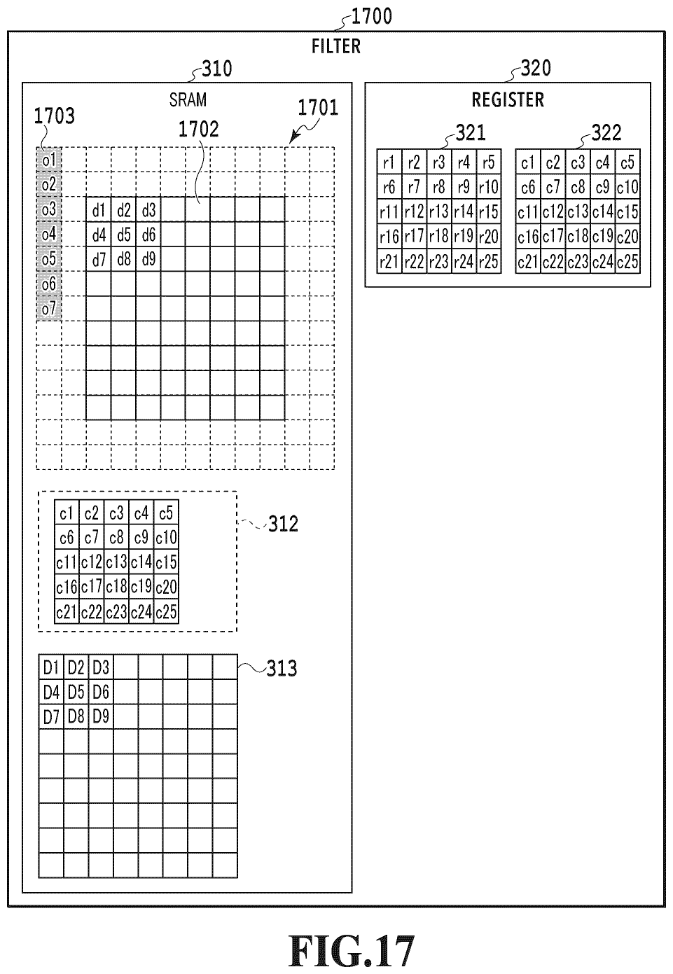

FIG. 17 is a diagram illustrating an example of the margin data spanning the multiple lines. In FIG. 17, a region 1702 shown with a solid line in an input data region 1701 in the SRAM 310 is a region to which the image block obtained from the DRAM 103 is deployed. Additionally, a region 1703 shown with a broken line and existing on the right, left, top, and bottom with a solid line indicates the range of the margin data required for the convolutional computation. It is indicated that the margin data of the range of two lines (two rows and two columns) around the image block is required in a case of the 5×5 filter. In addition, a state in which a region 1703 shown in gray in FIG. 17 holds the reference data o1 to o7 obtained from the DRAM 103 is indicated.

In the example in FIG. 17, a part of one line of the two lines of the margin data (the region 1703) concentratedly holds the data of o1 to o7 obtained from the DRAM 103. The other margin data is padded. In this case, since the reference data is partially used, as with the embodiment and the modifications described above, it is possible to reduce the used amount of the SRAM. However, the reference data is held while concentrating locally and separated from the padding region. If the reference data is taken by the method as described above, information of the real data is partially missed.

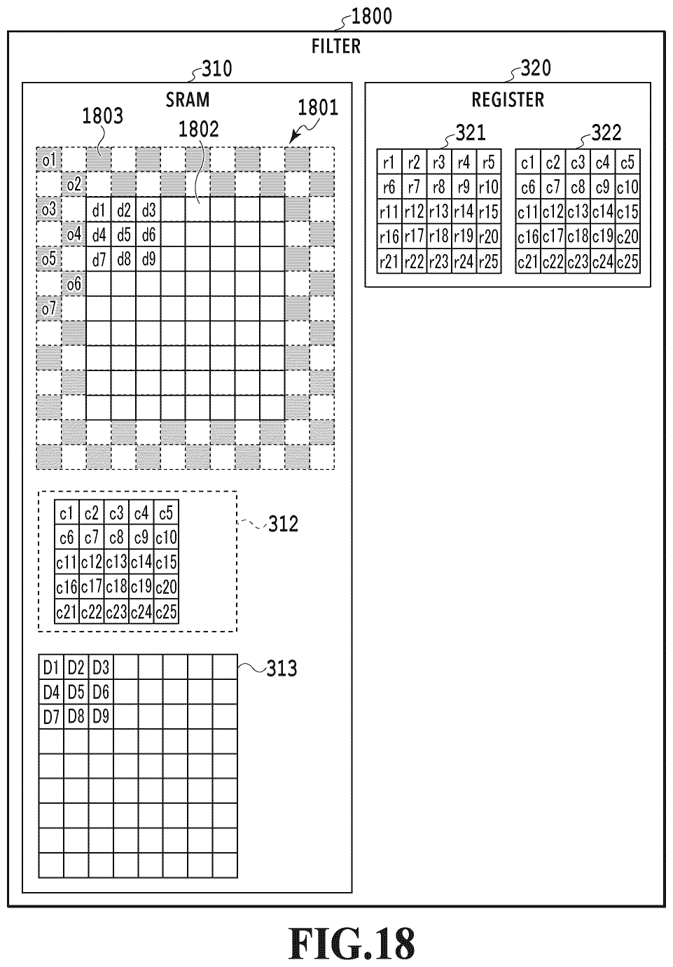

FIG. 18 is a diagram illustrating a data obtainment method according to a modification 3. The method illustrated in FIG. 18 is more preferable data obtainment method than that in FIG. 17. The example in FIG. 18 also illustrates a case where the range of the margin data required for the convolutional computation spans multiple lines. Multiple regions 1803 shown in gray in FIG. 18 are regions holding the reference data taken from the DRAM 103. The reference data o1 to o7 obtained from the DRAM 103 are arranged discretely so as not to concentrate locally. Specifically, the reference data o1 to o7 are arranged in the SRAM 310 in a staggered manner.

Thus, in a case where the margin data required for the convolutional computation spans multiple lines, preferably, the margin data obtained from the DRAM 103 are dispersedly arranged so as to prevent the concentration in one line. Thus, it is possible to prevent missing of the information of the original image data in a certain line. As a result, in the convolutional computation using the padding, it is possible to suppress decline in accuracy of the processing result.

Note that, although an example of the staggered arrangement in which the reference data is arranged in every other pixel is described in the example in FIG. 18, it is not limited to this example, and the arrangement may be skipped by the arbitrary number of pixels such as every other two pixels or every other three pixels. Additionally, as long as it is discrete arrangement, any arrangement may be applicable and the reference data may be arranged randomly in arbitrary positions. Moreover, in the present modification 3, in a case where the margin data required for the convolutional computation spans multiple lines, taking of the real data in only the top and bottom lines as illustrated in FIG. 10 or in only the right and left lines as illustrated in FIG. 14 is not prevented.

In either case, the reference data obtained by the inference unit 104 from the DRAM 103 and deployed to the SRAM 310 in the present embodiment is less than all the margin data required for the convolutional computation and more than that in a case of padding all the margin data. Thus, it is possible to suppress decline in accuracy of the processing result while reducing the capacity of the SRAM 310 required for the filtering processing of the inference unit 104.

Note that, in a case where the filtering processing is performed over multiple layers by the structure of the CNN using the inference unit 104, it is unnecessary to reduce the margin data of the present embodiment in all the layers, and the margin data of the present embodiment may be reduced by selecting one or more layers. In this case, as for the filter used in a layer with a high effect of the data reduction, the margin data may be reduced as described in the present embodiment. The layer with a high reduction effect is the last layer of the encoder unit 201, for example. This layer is preferable because the padding amount is small since the layer has a low resolution and it is possible to increase the resolution by upsampling in the subsequent layer.

Additionally, according to the position in the original image of the target data 421 (the image block) taken from the DRAM 103, the padding position (the position in which the margin data is reduced) may be changed. For example, in a case where the image block in a top end portion of the original image is obtained from the DRAM 103, the padding position is the top line since there is no pixel outside the top end portion of the original image data in the DRAM 103. Alternatively, the padding position is the top and bottom lines as illustrated in FIG. 10. Additionally, in a case where the image block in a left end portion of the original image is obtained from the DRAM 103, since there is no pixel outside the left end portion of the original image data in the DRAM 103, the padding position is only the left line. Alternatively, the padding position is the right and left lines as illustrated in FIG. 14, for example.

Additionally, the padding position may be changed for each image block taken from the DRAM 103. In this case, preferably, the padding position is changed randomly to prevent a specific periodicity. For example, in a case where the padding is performed always in the same position for all the image blocks, periodic accuracy deterioration occurs. It is possible to prevent periodic accuracy deterioration by dispersing the padding position as much as possible among the image blocks.

Note that, the padding position may be determined for each image block by storing in advance a program that determines which image block is padded and the position thereof into the ROM 102 of the printer 100 and executing the program by the CPU 101. Additionally, based on the information of the division position and the padding position set in advance in the ROM 102, the CPU 101 may determine which image block is padded and the position thereof.

The examples of the configuration and the inference of the inference unit 104 in the printer 100 in the first embodiment are described above. In the present embodiment, a part of the margin data required for the convolutional computation is obtained as the reference data, and the other portions are padded. Thus, it is possible to execute the inference using the CNN model in embedded equipment with poor calculation resources while suppressing decline in accuracy of the inference.

### Second Embodiment

In a second embodiment, in the printer 100 described in the first embodiment, a learning condition for obtaining the filter coefficient used in the inference is common with an inference condition in the inference unit 104. Thus, accuracy of a result of the inference is improved.

The accuracy of attribute probability eventually obtained as a result of the inference depends on the similarity between an image characteristic used in the inference and an image characteristic assumed in learning. The learning is processing of optimizing the filter coefficient by the CNN by using a massive amount of learning data and determining the filter coefficient proper for the extraction of the feature amount. Therefore, in the second embodiment, as described in the first embodiment, the inference condition considering the restriction in the hardware resource of the printer 100 is reflected also to the learning. In addition, the learned filter coefficient determined by the learning is set to the printer 100.

Particularly, in the present embodiment, the division condition of the computation data, the reference data obtainment condition, and the padding condition used in the inference and the learning are common. Additionally, the condition (hereinafter, referred to as a CNN condition) determining the structure of the CNN model such as the number of the processing layers, the filter size, and the number of contraction and expansion is common between the inference and the learning.

### System Configuration

Next, a system configuration of an information processing system 1900 of the second embodiment is described.

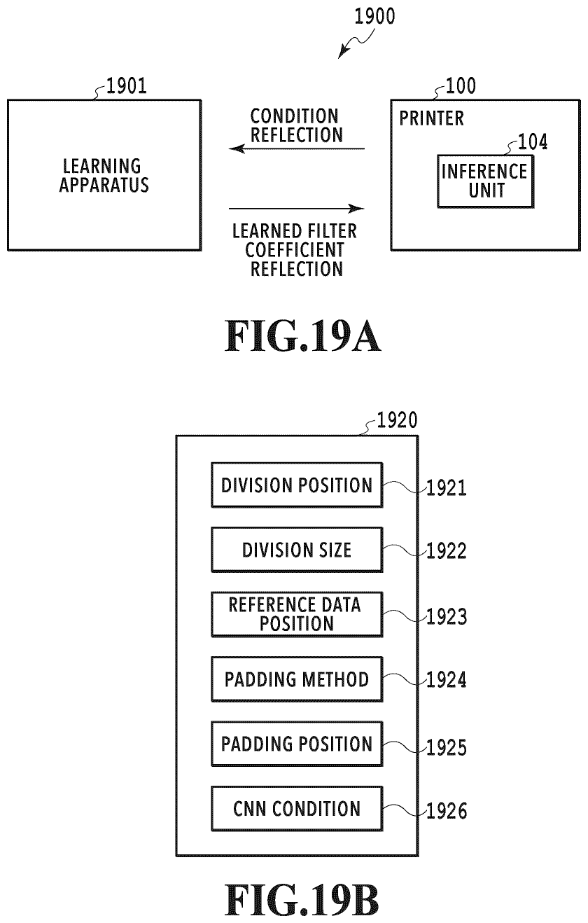

FIG. 19A is a diagram illustrating a relationship between the printer 100 as the inference apparatus and a learning apparatus 1901.

As illustrated in FIG. 19A, in the second embodiment, an example of the information processing system 1900 in which the learning apparatus 1901 and the printer 100 are formed as separated apparatuses is described. Note that, a configuration of the information processing system 1900 is not limited to this example and, for example, a configuration in which the printer 100 includes the inference unit and a learning unit together may be applicable. Additionally, as with the first embodiment, the printer 100 is an example of the inference apparatus as a product; however, it is not limited to the printer 100 and other embedded equipment may be applicable.

In the following description, the printer 100 is the printer 100 described in the first embodiment, the hardware configuration and the functional configuration are similar to that in the first embodiment, and the same units are provided with the same reference numerals.

The learning apparatus 1901 is an apparatus that generates the filter coefficient used in the inference executed by the inference unit 104 of the printer 100 and is formed of an information processing apparatus such as a personal computer (PC), for example. It is assumed that a hardware resource of the learning apparatus 1901 has higher performance in the computation speed and the storage capacity than that of the printer 100.

In the second embodiment, the inference condition in the printer 100 is reflected to the learning condition in a case where the learning apparatus 1901 generates the filter coefficient. Specifically, an obtainment condition of the computation data in the inference unit 104 of the printer 100 is reflected to an obtainment condition of the learning data in the learning apparatus 1901. Additionally, the structure of the CNN model in the learning apparatus 1901 is the same as the structure of the CNN model of the inference unit 104 of the printer 100. An arrow illustrated in FIG. 19A does not necessarily mean that the learning apparatus 1901 and the printer 100 are communicably connected to each other. The arrow indicates that the inference condition set to the printer 100 is reflected to the learning apparatus 1901 and that the learned filter coefficient generated by the learning apparatus 1901 is reflected to the printer 100 and used for the inference. The reflection of the condition and the filter coefficient may be manually set by the user.

FIG. 19B is a diagram illustrating an example of a condition 1920 reflected to the learning apparatus 1901. The condition 1920 reflected to the learning apparatus 1901 includes the division condition of data (learning data) used for the learning, the reference data obtainment condition, the padding condition, and the CNN condition. The division condition is a division position 1921 and a division size 1922. The reference data obtainment condition is a reference data position 1923. The padding condition is a padding method 1924 and a padding position 1925. These are similar contents as the division position 401, the division size 402, the reference data position 403, the padding method 405, and the padding position 406 set in the ROM 102 of the printer 100 in FIG. 4. A CNN condition 1926 is a condition related to the structure of the CNN model and is the number of the processing layers, the filter size, the number of contraction and expansion, and the like, for example. As for the CNN condition 1926 too, the same contents as the condition of the CNN model of the inference unit 104 of the printer 100 illustrated in FIG. 4 are reflected to the learning apparatus 1901.

In a case where the learning apparatus 1901 executes the learning, the learning data is divided and obtained based on the division position 1921 and the division size 1922, and the reference data specified based on the reference data position 1923 is obtained and held in a memory (a RAM 2130) of a learning unit 2000 of the learning apparatus 1901. Additionally, the padding data is added for the deficient data in the margin data required for the convolutional computation based on the padding method 405 and the padding position 406.

### Configuration of Learning Apparatus

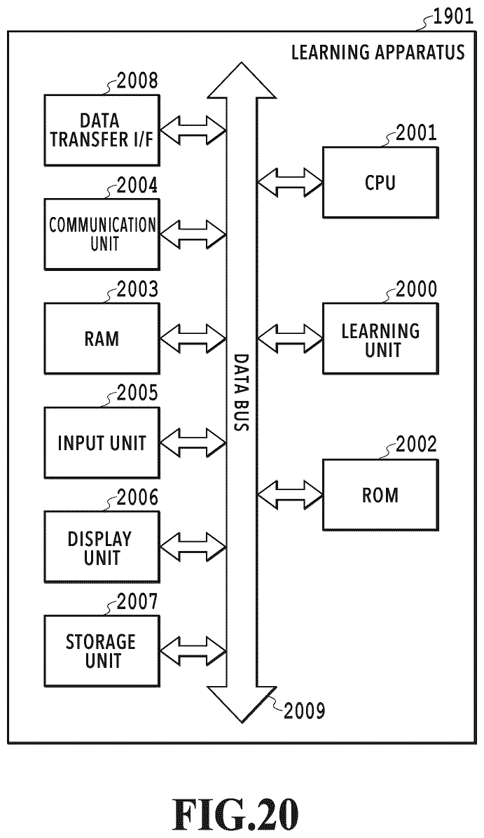

FIG. 20 is a diagram illustrating an example of a hardware configuration of the learning apparatus 1901. The learning apparatus 1901 includes a CPU 2001, the learning unit 2000, a ROM 2002, a RAM 2003, a communication unit 2004, an input unit 2005, a display unit 2006, a storage unit 2007, a data transfer I/F 2008, and the like, for example. These units are connected to the CPU 2001 via a data bus 2009. Note that, the configuration of the learning apparatus 1901 is not limited to the example in FIG. 20 and various configurations may be appropriately applicable.

The CPU 2001 executes various types of processing by using the RAM 2003 as a working area according to a program held in the ROM 2002 or the storage unit 2007. The RAM 2003 is a volatile storage region and used as a working memory and the like. The ROM 2002 is a non-volatile storage region and holds a program, an operating system (OS), and the like according to the present embodiment. The storage unit 2007 is a non-volatile storage device such as an HDD and an SSD and holds various types of data such as a program, data required to execute the program, and image data used for the learning.

The communication unit 2004 is an interface for communication with a network such as a LAN, a WAN, and the Internet. The display unit 2006 includes a display and a display control circuit and displays the data inputted from the CPU 2001. The input unit 2005 includes input equipment such as a pointing device that is a keyboard, a mouse, or the like and transmits the data inputted by the user via the input equipment to the CPU 2001. The data transfer I/F 2008 is an interface to transmit and receive the data to and from an external device. For example, a connection system in the data transfer I/F 2008 is not particularly limited and, for example, it is possible to use a USB, IEEE 1394, and the like. Additionally, either wired or wireless may be applicable.

The learning unit 2000 includes a filter (the computation circuit and a memory such as the RAM and the register) to execute the learning by the CNN and executes the learning according to the set condition 1920.

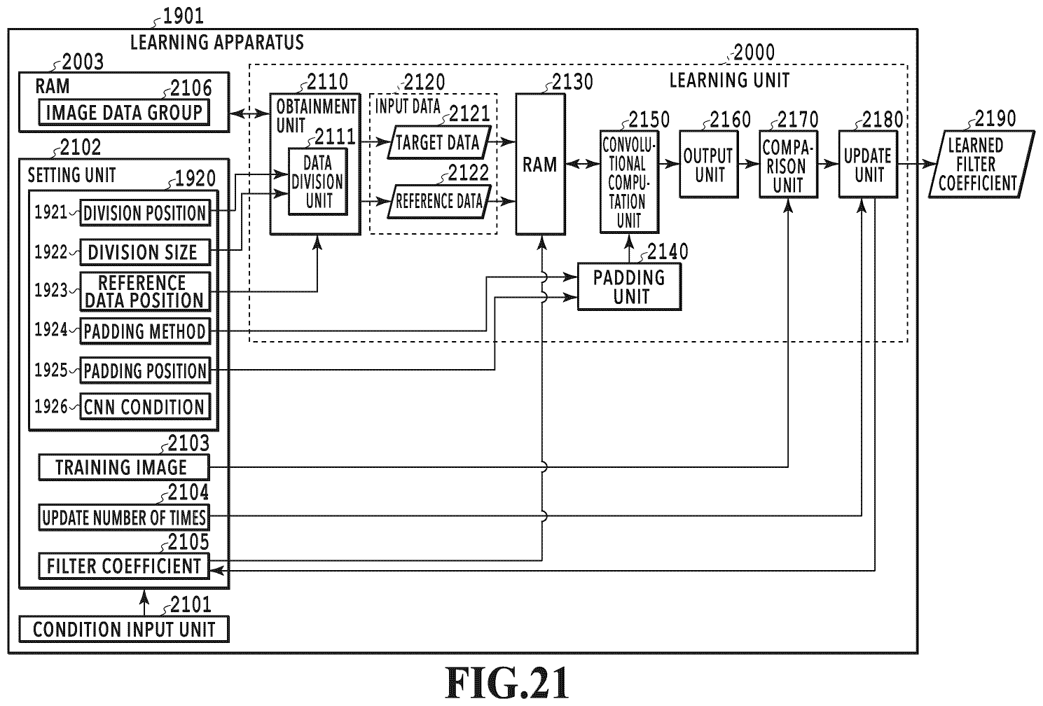

FIG. 21 is a diagram illustrating a functional configuration and a data processing process of the learning apparatus 1901. As illustrated in FIG. 21, the learning apparatus 1901 includes a condition input unit 2101, a setting unit 2102, and the learning unit 2000. The learning unit 2000 includes an obtainment unit 2110, the RAM 2130, a convolutional computation unit 2150, an output unit 2160, a comparison unit 2170, an update unit 2180, and the like. These functional units are implemented with the CPU 2001 executing the program held in the ROM 102, for example.

The RAM 2003 stores an image data group 2106, which is multiple pieces of learning data. The image data group 2106 is inputted from a device outside the learning apparatus 1901 via the communication unit 2004 or from a portable storage medium via the data transfer I/F 2008 and held in the RAM 2003. Note that, although FIG. 20 is a diagram assuming that the learning data is divided in a case where the learning unit 2000 reads the learning data from the RAM 2003, it is not limited thereto, and the data of the image block divided in advance by the preprocessing may be held in the RAM 2003. Additionally, the image block may be held in the RAM 2003 in a state in which reference data 2122 is added in advance to the image block.

The condition input unit 2101 accepts input of various conditions in the learning executed by the learning unit 2000. The inputted condition includes the condition 1920 illustrated in FIG. 19B described above. Specifically, the condition related to the division of the learning data (the division position 1921 and the division size 1922), the reference data obtainment condition (the reference data position 1923), the padding condition (the padding method 1924 and the padding position 1925), and the CNN condition 1926 are included.

Additionally, the condition input unit 2101 accepts input of a training image 2103, an update number of times 2104, and a filter coefficient 2105. The training image 2103 is image data indicating a correct answer and is compared with the output image obtained as a result of the convolutional computation in the comparison unit 2170. The update number of times 2104 is an upper limit value of the number of times of the repetition of updating the filter coefficient in the update unit 2180. As for the filter coefficient 2105, an arbitrary value is set as an initial value. For example, a random value is set to the filter coefficient 2105 as the initial value, and the value is gradually updated and optimized by repeating the learning. In the second embodiment, input of information to the condition input unit 2101 is performed manually by the user. The condition input unit 2101 transfers the accepted information to the setting unit 2102.

The setting unit 2102 receives the division condition of the learning data, the reference data obtainment condition, the padding condition, the CNN condition 1926, the training image 2103, the update number of times 2104, and the filter coefficient 2105 accepted by the condition input unit 2101 and sets the conditions to the learning unit 2000. The division condition is the division position 1921 and the division size 1922. The reference data obtainment condition is the reference data position 1923. The padding condition is the padding method 1924 and the padding position 1925.

Specifically, the setting unit 2102 sets the CNN condition 1926 to the learning unit 2000. The learning unit 2000 constructs the CNN model according to the CNN condition 1926. Additionally, the setting unit 2102 sets the division position 1921 and the division size 1922 to a data division unit 2111. Moreover, the setting unit 2102 sets the reference data position 1923 to the obtainment unit 2110. Furthermore, the setting unit 2102 sets the padding method 1924 and the padding position 1925 to a padding unit 2140. Additionally, the setting unit 2102 sets a training image (a correct answer) to the comparison unit 2170 and sets the update number of times to the update unit 2180.

The obtainment unit 2110, the data division unit 2111, the padding unit 2140, and the convolutional computation unit 2150 of the learning unit 2000 are similar to the obtainment unit 410, the data division unit 411, the padding unit 440, and the convolutional computation unit 430 of the inference unit 104 in FIG. 4. As with the SRAM described in the first embodiment and the modifications thereof illustrated in FIGS. 10, 14, and 16 to 18, the RAM 2130 includes the input data region, the filter coefficient storage region, and the output data storage region, for example.

Based on the condition 1920 set by the setting unit 2102, the obtainment unit 2110 obtains the learning data from the image data group 2106 in the page unit that is held in the RAM 2003. The obtainment unit 2110 reads the learning data by the data division unit 2111 as target data 2121 sequentially in the processing order while dividing the learning data into the image block in a predetermined size and deploys the read data to an input data region of the RAM 2130 of the learning unit 2000. In this process, the obtainment unit 2110 may obtain information of the division position. This is because the method of obtaining the reference data may be changed according to the division position. In the second embodiment, the target data 2121 of the divided one image block is deployed to the input data region. Additionally, the obtainment unit 2110 obtains the reference data 2122 from a peripheral pixel group existing in the original image (the learning data) of the obtained image block (the target data 2121) and deploys the reference data 2122 to the input data region of the SRAM 310.

Based on the information of the reference data position 1923 and the information of the division position 1921 and the division size 1922 set to the setting unit 2102, the obtainment unit 2110 can specify the position in the original image from which the reference data can be obtained. The obtainment unit 2110 obtains the reference data 2122 from a data group existing around the obtained target data 2121, that is, the original image 501 held in the RAM 2003, and deploys the reference data 2122 to the input data region. Out of the margin data, the other data except the reference data 2122 is padded by the padding, for example.

The padding unit 2140 pads the deficient data in the convolutional computation based on the padding method 1924 and the padding position 1925 set by the setting unit 2102.

As described above, the condition 1920 set to the setting unit 2102 of the learning apparatus 1901 is the same as the division position, the division size, the reference data position, the padding method, and the padding position set to the inference unit 104 described in the first embodiment. Accordingly, input data 2120 deployed to the RAM 2130 of the learning unit 2000 is obtained with the size and the method of obtaining the reference data that are similar to that of the input data in the inference unit 104 of the printer 100. The padding data is applied also similarly to the padding data in the inference unit 104 of the printer 100. For example, as with the input data of the inference unit 104 illustrated in FIG. 10, the padding data is held in the RAM 2130 in a state in which a part of the margin data is reduced.

An arbitrary initial value is set as the filter coefficient 2105. For example, in a case where the processing layer is formed of n filters, the obtainment unit 2110 sets the initial value for each of the filter coefficients corresponding to the n filters and holds the initial value in the filter coefficient region of the RAM 2130.

The convolutional computation unit 2150 reads out the filter coefficient of a processing target layer from the filter coefficient region of the RAM 2130 and sets the filter coefficient to the coefficient register. Additionally, the convolutional computation unit 2150 sets the data of a predetermined computation range from the computation data including the input data 2120 and the padding data held in the RAM 2130 as a register for computation and executes the sum-of-products computation with the filter coefficient set to the coefficient register. The convolutional computation unit 2150 executes computation for all the pixels of the computation data while sliding the computation range and writes the output image (the feature amount) as the computation result in the output data region of the RAM 2130. In a case where there is a next layer, the convolutional computation is repeatedly performed by inputting the output image. Once the convolutional computation ends for all the processing layers, the output unit 2160 obtains the feature amount vector.

The comparison unit 2170 calculates an error by comparing the feature amount vector outputted by the output unit 2160 with the training image 2103 as the correct answer.

The update unit 2180 updates the filter coefficient in each neuron by propagating the error calculated by the comparison unit 2170 from an output layer side to an input layer side and calculating a gradient from this error. The learning of the next input image is performed by using the updated filter coefficient. Once reaching the upper limit value of the update number of times set by the setting unit 2102, the learning unit 2000 ends the learning. The learning unit 2000 outputs a learned filter coefficient 2190 as a result of the learning.

### (Method of Generating Filter Coefficient)

Here, processing of generating the filter coefficient in the learning apparatus 1901 (learning processing) is described in more detail.

### (Generation Environment)

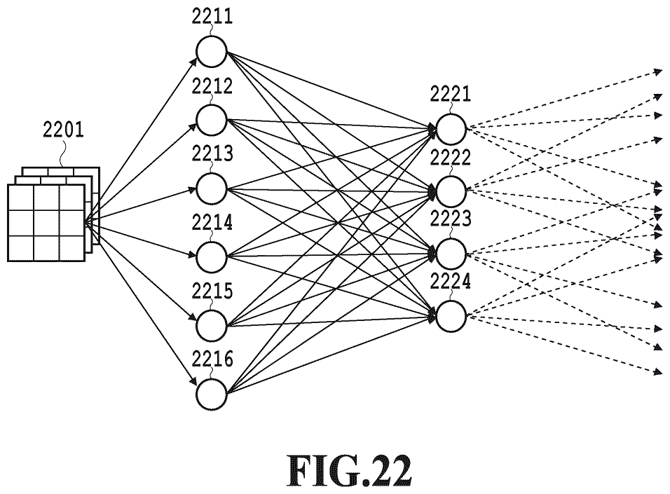

FIG. 22 is a schematic diagram of the vicinity of an input unit of a typical CNN model. In the present embodiment, a case where the filter coefficient is generated by using the learning apparatus 1901 illustrated in FIG. 19A is described. Data 2201 is data inputted to the learning apparatus 1901. For example, in a case where the input data is the image data, the input data is prepared for three channels of R, G, and B for each coordinate. Neurons 2211 to 2216 are portions forming a processing layer of the input data 2201. The neurons 2211 to 2216 are filters to convolute the input data 2201 that hold different filter coefficients, respectively. This is because one filter extracts one characteristic, and in order to extract multiple different features, multiple types of filter processing have to be performed. The filter coefficient for the three channels of R, G, and B is held in each filter (the neurons 2211 to 2216). As described later, a value of the filter coefficient in an initial state is a variable as a generation target. For example, the neuron 2211 holds the filter coefficients of 3×3 for convoluting the input data 2201 for the three channels of R, G, and B.

In the example in FIG. 22, six processing layers are provided. As a result, in a case where the processing of the first layer ends, six features are extracted. Neurons 2221 to 2224 are a second processing layer. In the second processing layer, the results from the neurons 2211 to 2216 of the first layer as inputs, and similar convolutional computation is performed by the four processing layers (the neurons 2221 to 2224). Next, an activating function is described.

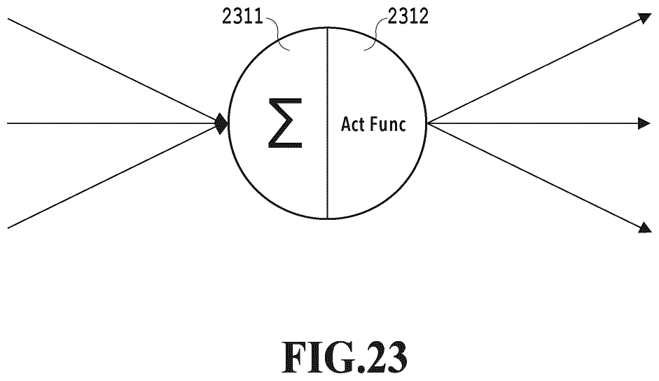

FIG. 23 is a schematic diagram illustrating an overview of a processing unit in the processing layer. In the processing layer, the inputted data is convoluted by a convolutional computation unit 2311, and a result thereof is inputted to an activating function unit 2312. The activating function unit 2312 is a function having a non-linear characteristic. Specifically, a sigmoid function, an ReLU function, and the like are used. The activating function unit 2312 executes function computation by using the computation result of the convolutional computation unit 2311 as an input and outputs the result thereof. Depending on the input from the convolutional computation unit 2311, the output from the activating function unit 2312 may be weak. That is, whether the information is transferred from the activating function unit 2312 to the next layer is determined depending on the coefficient held in the convolutional computation unit 2311. The feature amount is generated by repeatedly executing the processing as described above to the next layer and executing the processing until reaching the last layer of the CNN model (not illustrated).

### (Obtainment of Error)

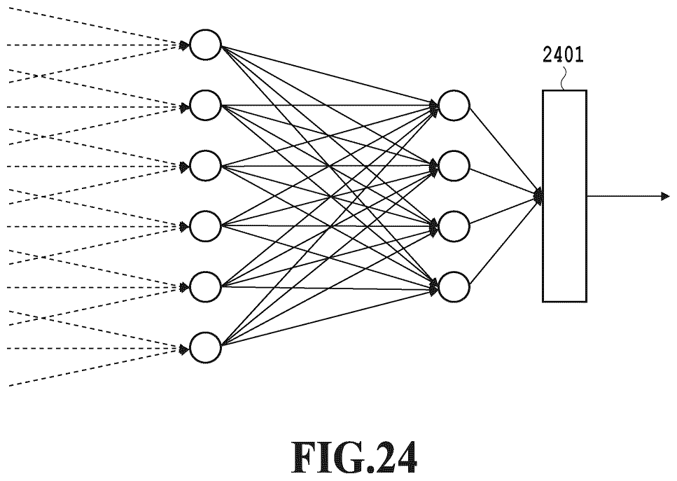

FIG. 24 is a schematic diagram illustrating the vicinity of an output unit of the typical CNN model. Once reaching the last layer after the input in FIG. 22, the feature amount is outputted through an activating function 2401. Thus, the feature of the inputted image is obtained. As above, the CNN model obtains the feature amount from the input data by using a massive amount of filter calculation and the activating function.

It is possible to prepare the true feature amount indicating the feature of the input image by a method other than the learning. For example, it is possible to determine the value by determination visually by a person. Hereinafter, this value (the true feature amount) is referred to as a “correct answer” or training data. The error of the input data is obtained by obtaining a difference between the feature amount obtained from the CNN model and the correct answer.

### (Error Propagation)

The filter coefficient in each neuron is updated by propagating the error between the output of each layer and the correct answer from an output layer side to an input layer side and calculating a gradient from this error. This is referred to as an error back-propagation method. The error back-propagation method is a publicly-known technique and is described in Japanese Patent Laid-Open No. H6-96046, for example. As a result of the error propagation as described above, the filter coefficients in all the CNN layers are updated. Note that, the error back-propagation method is an example, and the filter coefficient may be updated by using another method.

### (Overall Flow of Learning Processing)

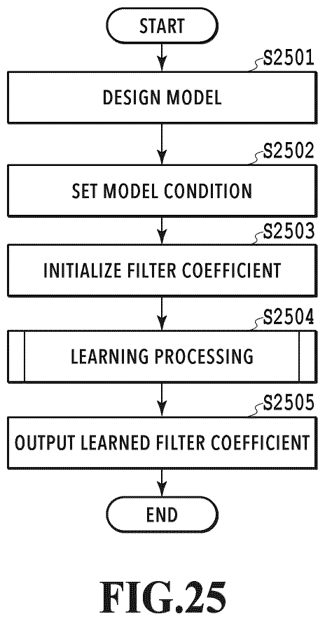

Next, an overall flow of the learning processing executed by the learning apparatus 1901 is described. FIG. 25 is a flowchart describing the overall flow of the learning processing executed by the learning apparatus 1901. A program to execute the processing illustrated in the present flowchart is stored in the storage unit 2007 or the ROM 2002 of the learning apparatus 1901. The CPU 2001 executes the processing in the present flowchart by calling this program and using the RAM 2003 as a working area. For example, once the user instructs starting of the learning via the input unit 2005, the CPU 2001 starts the present flowchart.

In S2501, the CPU 2001 (the condition input unit 2101) accepts designing of the structure of the CNN model for the learning by the user. The CPU 2001 accepts input of a parameter related to the model structure. The parameter related to the model structure includes the number of layers of the convolutional layers (filters), the filter size, the number of times of contraction and expansion, and the like and is comparable to the CNN condition 1926 in the above-described condition 1920. Note that, an already-existing model may be used instead of the parameter.

In S2502, the CPU 2001 (the condition input unit 2101) accepts setting of the model condition. The model condition includes the division position 1921, the division size 1922, the reference data position 1923, the padding method 1924, and the padding position 1925 in the above-described condition 1920. Additionally, the CPU 2001 also accepts the training image 2103 and the update number of times 2104.

In S2501 and S2502, the user sets the model structure (the CNN condition) and the model condition similar to that of the inference unit 104 of the printer 100 to the learning apparatus 1901. In this process, the condition input unit 2101 of the learning apparatus 1901 (the CPU 2001) may display a UI (user interface) screen for the user to set the model structure and the model condition.

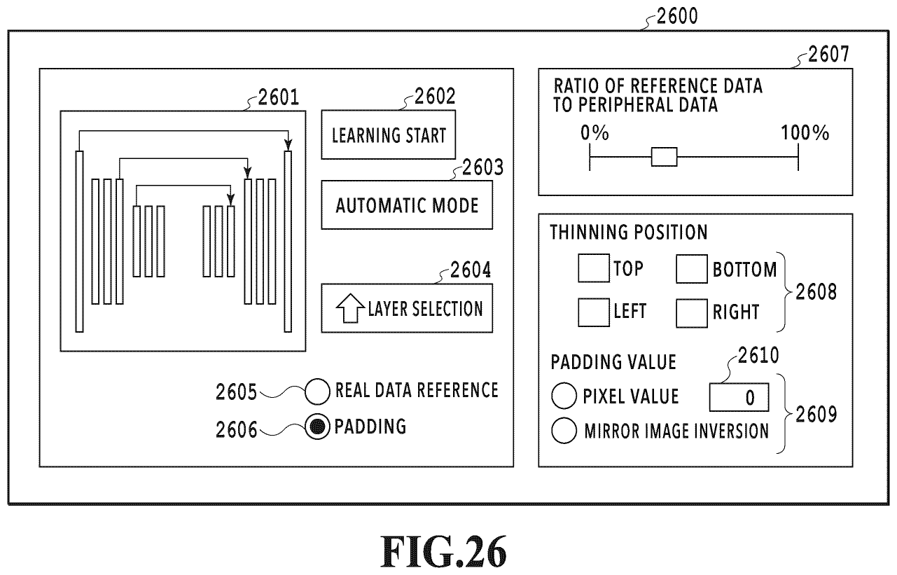

FIG. 26 is an example of a UI screen 2600 for the user to set the model structure and the model condition. The UI screen 2600 is provided with a model structure setting region 2601, a learning start button 2602, a mode selection button 2603, and a layer selection button 2604.

In the model structure setting region 2601, the user sets the parameter related to the model structure such as the number of convolutional layers, the filter size, and the number of times of contraction and expansion. The model structure setting region 2601 displays a model structure drawing according to the set parameter. In the second embodiment, the user sets the model structure (at least the number of layers, the filter size, and the number of times of contraction and expansion) that is the same as the CNN model structure of the printer 100. Note that, based on the model structure set in this process, a range of the margin data required for the convolutional computation in each filter is determined.

The mode selection button 2603 is an operation unit to perform an operation to select an automatic mode in which the reference data obtained from the margin data is automatically set or a manual mode in which the reference data is manually set by the user. In a case where the automatic mode is selected by the user, the CPU 2001 automatically sets a reference data position for the entire model. Note that, in the automatic mode, the CPU 2001 may allow the user to set a ratio of the reference data to the margin data. A setting screen 2607 for this process may be displayed as a pop-up screen. It is possible to set an arbitrary value from 0% to 100% as the ratio of the reference data to the margin data. In a case where 100% is set, all the pixels of the margin data are formed of the reference data (the real data), and in a case where 0% is set, all the pixels of the margin data are padded. On the setting screen 2607, the user may set the same ratio as the ratio of the reference data to the margin data in the inference unit 104 of the printer 100.

In the automatic mode, the ratio set on the setting screen 2607 is uniformly set to the entire model. Based on the ratio set by the user, the CPU 2001 determines the reference data position of each layer. Processing of the CPU 2001 in the automatic mode is described in a third embodiment.

In a case where the manual mode is selected by the user, the CPU 2001 accepts selection of the layer and input of advanced setting of the reference data position in the selected layer. The layer is selected with the user instructing any one of the layers of the model structure displayed in the model structure setting region 2601 while the layer selection button 2604 is being pressed. Regarding the selected layer, the CPU 2001 accepts selection from either the “real data reference” or the “padding” by the user operation. In a case where a radio button 2605 is set to ON, the “real data reference” is selected, and in a case where a radio button 2606 is set to ON, the “padding” is selected.

In a case where the “real data reference” is selected, the setting in which the margin data is all obtained as the real data (the data of the original image) for the selected layer is applied. In a case where the “padding” is selected, the CPU 2001 additionally accepts setting of a thinning position 2608 and a padding value 2609.

It is possible to select one or more of the top, bottom, left, and right as the thinning position 2608. For example, in a case where the top and bottom are selected by the user, as illustrated in FIG. 10, the real data in the top and bottom regions out of the margin data required for the convolutional computation is not taken and padded. That is, in the left and right regions out of the margin data, the real data is taken as the reference data, and the padding data is applied to the top and bottom regions. In a case where the right and left are selected by the user as the thinning position 2608, as illustrated in FIG. 14, the real data in the right and left regions out of the margin data required for the convolutional computation are not taken and padded. That is, in the top and bottom regions out of the margin data, the real data is taken as the reference data, and the padding data is applied to the right and left regions. Note that, any one of only the top, only the bottom, only the left, or only the right may be selected as the thinning position.

In the example in FIG. 26, it is possible to select a pixel value or mirror image inversion as the padding value 2609. In a case where the pixel value is selected by the user, the CPU 2001 accepts input of an arbitrary real number value into an input field 2610. In this case, the CPU 2001 pads a pixel deficient in data by using the inputted value as the padding data. In the example in FIG. 26, a state in which “O” is inputted in the input field 2610 is illustrated. In a case where the mirror image inversion is selected by the user, the CPU 2001 inverts a part of the input data inputted to the learning unit 2000 as the mirror image inversion and pads the pixel deficient in data. Note that, although it is possible to select either of the pixel value and the mirror image inversion as the padding value 2609 in the example in FIG. 26, it is not limited thereto, and another padding method may be selectable. For example, an average value of pixel values of multiple pixels existing around the padding position may be applicable.

The thinning position set by the thinning position 2608 of the UI screen 2600 is set to the setting unit 2102 as the padding position 1925. Out of the margin data required for the convolutional computation, a pixel except the position set by the thinning position 2608 is set to the setting unit 2102 as the reference data position 1923. Additionally, the padding value 2609 set on the UI screen 2600 is set to the setting unit 2102 as the padding method 1924.

In the second embodiment, the user selects the manual mode on the UI screen 2600 and sets the thinning position 2608 and the padding value 2609 so as to obtain the same condition as that of the margin data of the printer 100. Thus, out of the model condition that needs setting in the learning apparatus 1901, the reference data position 1923, the padding method 1924, and the padding position 1925 are set.

Note that, although discrete arrangement and staggered arrangement are not included as options of the thinning position 2608 in the example of the UI screen 2600 in FIG. 26, these arrangements may be included as options. In addition, a different value may be settable as the padding value depending on the channel or the processing layer. Additionally, out of the model condition, setting of the division position 1921 and the division size 1922 may also be included on the UI screen 2600. In the present embodiment, user sets the division position 1921 and the division size 1922 of the image so as to be the same as the division condition of the image data of the printer 100. Moreover, the same program for data division may be executed by each of the printer 100 and the learning apparatus 1901. Thus, out of the condition that requires setting in the learning apparatus 1901, the division position 1921 and the division size 1922 are set.

The condition setting using the UI screen 2600 is an example, and the condition setting may be performed by another method. For example, the user may directly designates the model structure (CNN condition), the padding method, the padding position, the division position, the division size, the reference data position, and the like to the program code. Additionally, as for the setting of the model structure (setting of the CNN condition 1926), the learning apparatus 1901 may obtain the sharable CNN model published on the Web via the communication unit 2004 and may reflect the model to the program code.

As above, once the model designing and the model condition setting are completed, and the learning start button 2602 of the UI screen 2600 is operated by the user, the process proceeds to S2503.

In S2503, the CPU 2001 initializes the filter coefficient. The CPU 2001 sets an arbitrary value to the filter coefficient of the filter size set in S2501. The CPU 2001 sets a random value, for example.

In S2504, the CPU 2001 sets the CNN model, the model condition, and the filter coefficient set in S2501 to S2503 to the learning unit 2000 and starts the learning. The learning is described later. Once the learning is completed, the process proceeds to S2505.

In S2505, the CPU 2001 outputs the learned filter coefficient that is a learning result. With the above processing, the present flowchart ends.

### (Learning Processing)

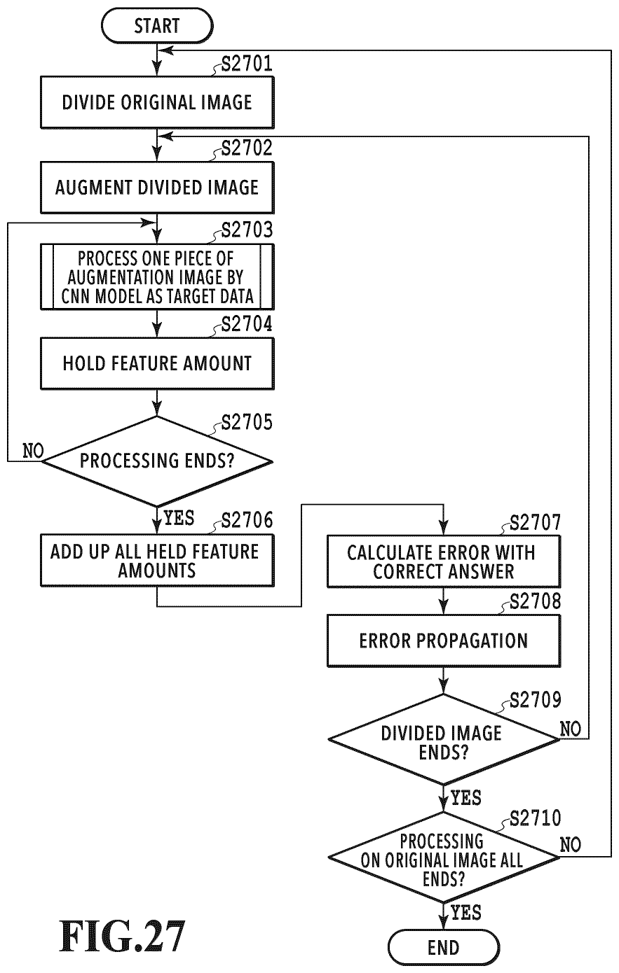

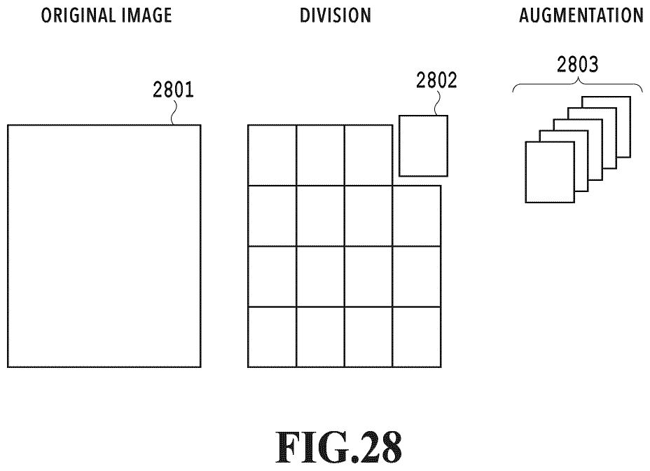

The learning processing executed in S2504 is described. FIG. 27 is a flowchart illustrating a flow of the learning processing. FIG. 28 is a diagram describing division and augmentation of the learning data. Once the processing to S2503 in FIG. 25 ends, the CPU 2001 of the learning apparatus 1901 subsequently starts the processing in the flowchart illustrated in FIG. 27. Until the present flowchart starts, the image data group 2106 for the learning is inputted in the learning apparatus 1901 and held in the RAM 2003.

In S2701, the CPU 2001 of the learning apparatus 1901 obtains an arbitrary piece of image data (hereinafter, referred to as an original image 2801) from the image data group 2106 and transfers the image data to the learning unit 2000. The data division unit 2111 of the learning unit 2000 divides the original image 2801 according to the division position 1921 and the division size 1922 set to the setting unit 2102 and obtains multiple image blocks 2802 illustrated in FIG. 28. Position information of the multiple image blocks 2802 in the original image is each added to the multiple image blocks 2802. The position information in the original image is information of the division position 1921.

In S2702, the CPU 2001 may increase the number of each image block 2802 by the augmentation processing. An augmentation image group 2803 including the multiple augmentation images is obtained by the augmentation processing. The augmentation image group 2803 is an aggregation of multiple pieces of augmentation image data generated by processing the image block 2802. The processing of the image block 2802 is replication by the mirror image inversion, partial overwriting processing of an arbitrary image element such as a photograph, a character, or graphics, and the like, for example. The position information in the original image 2801 is each added to the multiple pieces of augmentation image data. The augmentation image group 2803 may be held in the RAM 2130 of the learning unit 2000 or in the RAM 2003 or the storage unit 2007 of the learning apparatus 1901, or held in an arbitrary storage region such as an external storage. Note that, the processing in S2701 and S2702 may be executed by the learning unit 2000.

In S2703, the obtainment unit 2110 of the learning unit 2000 sequentially obtains an arbitrary piece of the augmentation image data from the augmentation image group 2803 as the target data 2121 and executes the learning by the CNN model. In the present embodiment, the obtainment unit 2110 of the learning unit 2000 obtains one piece of the augmentation image data and deploys the augmentation image data to the RAM 2130. In this process, based on the information of the reference data position 1923 set to the setting unit 2102, the obtainment unit 2110 also obtains the reference data 2122 around the obtained augmentation image data and deploys the reference data 2122 to the RAM 2130.

For example, in a case where the thinning position 2608 is set as the top and bottom on the UI screen 2600 in FIG. 26, the obtainment unit 2110 obtains data on the right side and the left side of the margin data from the pixel group around the augmentation image data (the target data 2121) in the original image 2801. The thus-obtained reference data 2122 and augmentation image data (target data 2121) are deployed to the input data region of the RAM 2130 as the input data 2120 illustrated in FIG. 21. Additionally, the obtainment unit 2110 obtains the filter coefficient held in advance in the ROM 2002. In a case where there are multiple layers to be processed by the filter, the obtainment unit 2110 obtains multiple filter coefficients. The obtainment unit 2110 holds the received one or more filter coefficients in the filter coefficient region of the RAM 2130.

The convolutional computation unit 2150 sets the filter coefficient of the target layer to the coefficient register and sequentially sets the data of the computation range out of the input data deployed to the input data region of the RAM 2130 to the register for computation to execute the convolutional computation. Note that, in early phase of the learning, an arbitrary random value is set as the filter coefficient. Additionally, in a case where the data of the computation range is deficient, the padding unit 2140 performs the padding. The padding unit 2140 applies the padding data to the register for computation based on the information of the padding method and the padding position set to the setting unit 2102. The convolutional computation unit 2150 executes the convolutional computation while sliding the computation range and writes the computation result into a corresponding pixel of the output data region. Once the convolutional computation for the input data deployed to the input data region ends, an output image indicating the feature amount is obtained.

In a case where there is a next layer, the convolutional computation unit 2150 sets the filter coefficient of the target layer to the coefficient register and sequentially executes the convolutional computation for the input data deployed to the input data region to write the computation result into the corresponding pixel of the output data region. The above processing is executed for all the pixels of the input data. In a case where there is yet another next layer, the CNN processing is executed by using an output of the previous layer as an input for the next layer. As a result of the CNN processing, the output unit 2160 obtains the feature amount vector of the inputted augmentation image data.

In S2704, the output unit 2160 holds the feature amount vector obtained in S2603 in the RAM. In S2705, the output unit 2160 determines whether the processing for all pieces of the augmentation image data ends. If the processing does not end, the process returns to S2703. If the processing for all the augmentation images ends, the process proceeds to S2706.

In S2706, the output unit 2160 adds up all the feature amount vectors obtained in the processing so far. The added-up feature amounts are hereinafter referred to as a “total feature amount”. The output unit 2160 transfers the total feature amount to the comparison unit 2170. In S2707, the comparison unit 2170 compares (obtains a difference between) the total feature amount obtained from the output unit 2160 and the training image 2103 and calculates the error. The training image 2103 is a correct answer vector obtained by adding up the number of times the same as the number of times of the augmentation processing and is set by the setting unit 2102.

In S2708, the update unit 2180 propagates the error calculated in S2707 to the CNN model and updates the filter coefficient. As a result of this error propagation, the filter coefficients of all the layers used in the CNN model are determined.

In S2709, the learning unit 2000 determines whether the processing from the augmentation to the error propagation (S2702 to S2708) for all the image blocks ends. If the processing does not end, the process returns to S2702, and the processing for the next image block is started from the augmentation. Note that, in the next learning, the filter coefficient to which the result of the error propagation executed in the immediately preceding processing is reflected is used. With the repeated execution of the learning processing above, the filter coefficient is sequentially optimized.

If the processing from the augmentation to the error propagation (S2702 to S2708) for all the divided images is performed the number of times of update that is set by the setting unit 2102, the process proceeds to S2710.

In S2710, the CPU 2001 determines whether the above-described learning for all the data in the inputted image data group 2106 ends. If the learning does not end, the process returns to S2701, and repeats the processing from S2701 to S2709. If the learning for all the data in the inputted image data group 2106 ends, the processing in the present flowchart ends. Note that, although the augmentation is executed after the image is divided in the present embodiment, it is not limited thereto. The original image may be augmented first, and thereafter the division may be performed.

The filter coefficient obtained by the learning can be outputted as the parameter. The CPU 2001 of the learning apparatus 1901 outputs the filter coefficient obtained by the learning to a predetermined output destination according to an instruction from the user. The output destination is a storage medium connected to the data transfer I/F 2008, the printer 100 connected via the data transfer I/F 2008 or the communication unit 2004, an external apparatus, and the like, for example.

The printer 100 obtains the filter coefficient from the storage medium or the communicably connected learning apparatus 1901. The obtained filter coefficient is stored in the ROM 102 of the printer 100. Thus, the inference unit 104 of the printer 100 can execute the inference by using the filter coefficient generated by the learning apparatus 1901. This filter coefficient is determined by the learning executed under a condition similar to the CNN condition, the division condition, the reference data obtainment condition, and the padding condition in the inference executed by the printer 100. Therefore, the attribute accuracy obtained as a result of the inference is improved. This is because the filter coefficient is determined based on also the reliability of a “portion in which the margin data is reduced and the padding is performed” in a case where the filter coefficient is optimized in the learning.

Specific description is provided. In the inference in the printer 100, assuming that the top and bottom regions out of the margin data required for the convolutional computation of the target data are not obtained as illustrated in FIG. 10. In this case, as for the data learned by the learning unit 2000 too, the top and bottom regions out of the margin data are not obtained and the data is applied by the padding. With the learning in this way, since it is difficult for the error of the feature amount of the “top and bottom regions” to converge, the filter coefficient converges to the filter coefficient that is unlikely to be affected by the position. In a case where the thus-generated filter coefficient is implemented to the ROM 102 of the printer 100, the inference unit 104 of the printer 100 also outputs the feature amount obtained by using the computation data in which the top and bottom regions are padded. Therefore, it is possible to obtain the feature amount that underestimates the reliability. Thus, it is possible to enhance the reliability of the feature amount as the inference result.

Note that, in the present embodiment, as an example comparable to the data obtainment method illustrated in FIG. 10, an example in which the data of the top and bottom regions out of the margin data is thinned (not obtained) and padded in a case of obtaining the augmentation image data for the learning is described. However, the present embodiment is not limited to this example, and in a case where the inference unit 104 of the printer thins the right and left margin data as illustrated in FIG. 14, the data of the right and left regions out of the margin data may be thinned (not obtained) and padded in a case of obtaining the augmentation image data for the learning. Additionally, in a case where the inference unit 104 of the printer thins the data in a staggered manner as illustrated in FIG. 16, the margin data may be thinned in a staggered manner and the data of the deficient portion may be padded in a case of obtaining the augmentation image data for the learning. Moreover, the range of the margin data is not limited to one line and may be multiple lines. In this case too, in a case where the inference unit 104 of the printer thins the margin data in a staggered manner as illustrated in FIG. 18, the margin data may be thinned (reduced) in a staggered manner and the data of the deficient portion may be padded in a case of obtaining the augmentation image data for the learning. In any case, the learning apparatus 1901 obtains the computation data under the division condition, the reference data obtainment condition, and the padding condition the same as that of the inference unit 104 of the printer 100 to execute the learning. Thus, it is possible to enhance the accuracy of the feature amount eventually obtained.

### Third Embodiment

Next, the automatic mode is described as the third embodiment. The automatic mode is selected by operating the mode selection button 2603 on the UI screen 2600 illustrated in FIG. 26 in the learning apparatus.

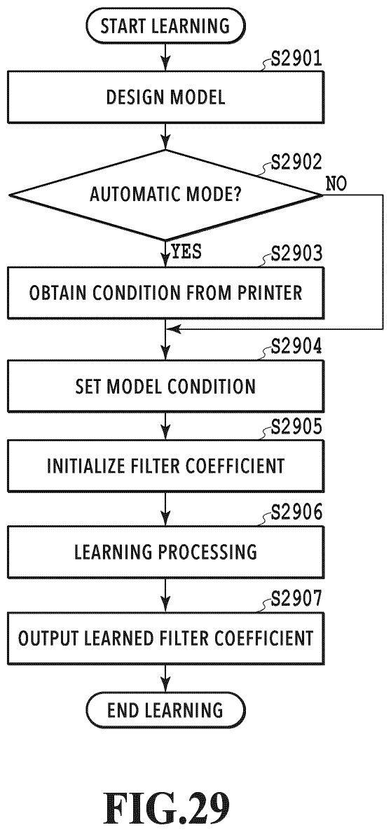

FIG. 29 is a flowchart illustrating an overall flow of the learning processing in the third embodiment. Note that, S2901 and S2904 to S2907 in the flowchart in FIG. 29 are processing corresponding to S2501 and S2502 to S2505 in FIG. 25, respectively. That is, the processing illustrated in FIG. 29 is different from the second embodiment in that processing in S2902 and S2903 is added after S2501 in FIG. 25. In the following description, a different point from the second embodiment is mainly described. Note that, in the third embodiment, as with the second embodiment, the learning condition to obtain the filter coefficient used in the inference is common with the inference condition in the inference unit 104. Thus, the accuracy of the attribute probability obtained eventually as a result of the inference is improved.

### (System Configuration and Functional Configuration)

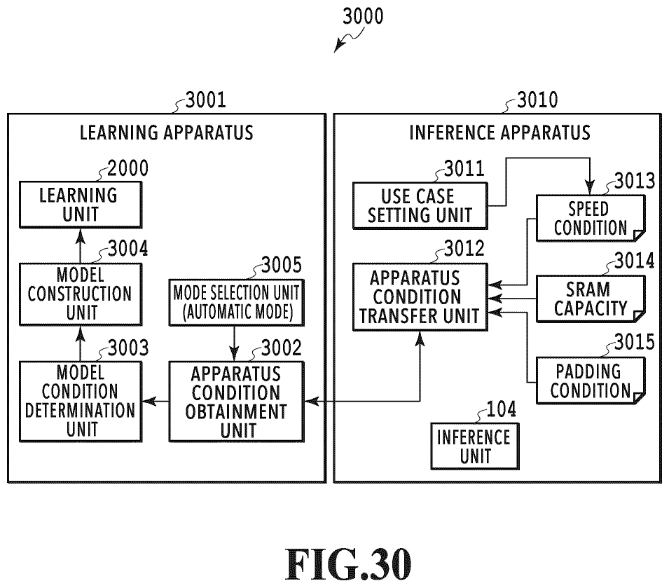

A system configuration and a functional configuration of an information processing system 3000 in the third embodiment is described. FIG. 30 is a diagram illustrating the system configuration and the functional configuration of the information processing system 3000 in the third embodiment. As illustrated in FIG. 30, the information processing system 3000 in the third embodiment includes an inference apparatus 3010 and a learning apparatus 3001, and the inference apparatus 3010 and the learning apparatus 3001 are communicably connected to each other via a data transfer unit or a communication unit of each apparatus. A hardware configuration of the learning apparatus 3001 is similar to that of the learning apparatus 1901 illustrated in FIG. 20. The inference apparatus 3010 is embedded equipment including the inference unit, which is the printer 100 illustrated in FIG. 1, for example, and a hardware configuration thereof is similar to that of the printer 100 illustrated in FIG. 1.

In the third embodiment, the learning apparatus 3001 includes the learning unit 2000, an apparatus condition obtainment unit 3002, a model condition determination unit 3003, a model construction unit 3004, and a mode selection unit 3005. The inference apparatus 3010 includes the inference unit 104, a use case setting unit 3011, and an apparatus condition transfer unit 3012. The ROM 102 or the DRAM 103 of the inference apparatus 3010 holds a speed condition 3013, an SRAM capacity 3014, and a padding condition 3015. These functional units are implemented with the CPU executing the program held in the ROM in each apparatus, for example.

The learning unit 2000 of the learning apparatus 3001 is similar to the learning unit 2000 in the second embodiment illustrated in FIG. 21. In a case where the automatic mode is selected in the mode selection unit 3005, the apparatus condition obtainment unit 3002 requests the inference apparatus 3010 to provide an apparatus condition and receives the apparatus condition transferred from the inference apparatus 3010. The apparatus condition includes the speed condition 3013, the SRAM capacity 3014, and the padding condition 3015. In a case where the inference apparatus 3010 is a printer, the speed condition 3013 is an upper limit value of the printing speed, for example, which is determined by the use case setting unit 3011 and held in the ROM 102. The SRAM capacity 3014 is a capacity (a circuit scale) of the SRAM used for the filter of the inference unit 104, which is stored in advance in the ROM 102.

The model condition determination unit 3003 determines the model condition of the learning unit 2000 based on the apparatus condition of the inference apparatus 3010 that is obtained by the apparatus condition obtainment unit 3002 and sets the model condition to the model construction unit 3004. Specifically, the model condition determination unit 3003 determines the model condition, which is particularly the reference data obtainment condition, so as not to exceed values of the speed condition 3013 and the SRAM capacity 3014 of the inference apparatus 3010. A method of determining the model condition is described later.

The model construction unit 3004 constructs the CNN model based on information for constructing the CNN model obtained from the inference apparatus 3010. In the third embodiment, as the information for constructing the CNN model, the apparatus condition obtainment unit 3002 obtains the apparatus condition of the inference apparatus 3010 from the inference apparatus 3010. The model condition determination unit 3003 determines the model condition based on the apparatus condition, and the model construction unit 3004 constructs the CNN model based on the determined model condition.

The mode selection unit 3005 accepts the selection by the user, which selects either the automatic mode in which the reference data obtainment condition is automatically set or the manual mode in which the reference data obtainment condition is manually set. For example, either the automatic mode or the manual mode is selected by operating the mode selection button 2603 on the UI screen 2600 illustrated in FIG. 26. In the third embodiment, the automatic mode is selected.

The inference unit 104 of the inference apparatus 3010 is similar to the inference unit 104 in the first embodiment illustrated in FIG. 4. The use case setting unit 3011 accepts the setting of a use case that can be set by the inference apparatus 3010.

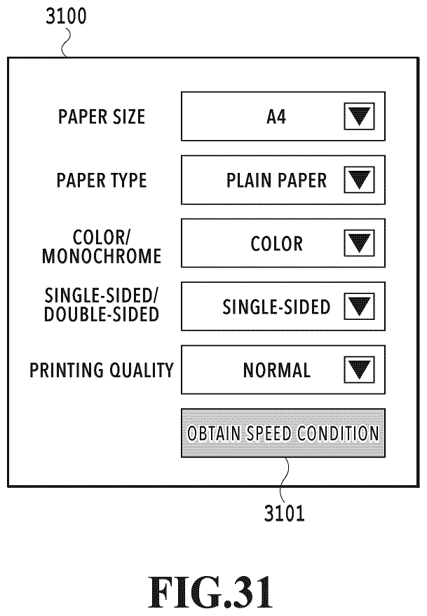

FIG. 31 is a diagram illustrating an example of a UI screen 3100 of the printing setting as an example of the use case. For example, the use case setting unit 3011 displays the UI screen 3100 for the setting of the use case illustrated in FIG. 31 on the operation panel 106 of the printer and accepts input of multiple parameter values by the user. The parameter is a paper size, a paper type, color/monochrome selection, single-sided/double-sided selection, printing quality, and the like, for example. The use case setting unit 3011 sets the speed condition that does not limit a paper conveyance speed and an operation speed of a printing head that are requested based on the inputted parameter values. Information of the speed condition may be held in advance in the ROM 102 for each use case, or the paper conveyance speed and the operation speed of the printing head that are requested according to the set use case may be obtained to allow the CPU 101 to determine the speed condition.

In a case of receiving the request to provide the apparatus condition from the learning apparatus 3001, the apparatus condition transfer unit 3012 transfers the apparatus condition including the speed condition 3013, the SRAM capacity 3014, and the padding condition 3015 held in the ROM 102 or the DRAM 103 to the learning apparatus 3001. Note that, the learning apparatus 3001 may obtain the speed condition via PC software mounted on the learning apparatus 3001 such as a printer driver.

### (Overall Flow of Learning Processing)

A flow of the learning processing executed by the learning apparatus 3001 in the third embodiment is described with reference to FIG. 29. The program to execute the processing illustrated in the present flowchart is stored in the storage unit 2007 or the ROM 2002 of the learning apparatus 3001. The CPU 2001 executes the processing in the present flowchart by calling this program and using the RAM 2003 as a working area. For example, once the user instructs starting of the learning processing via the input unit 2005, the CPU 2001 starts the present flowchart.

In S2901, the CPU 2001 of the learning apparatus 3001 accepts designing of the structure of the CNN model for the learning by the user. The CPU 2001 accepts the input of the parameter related to the model structure. The parameter related to the model structure includes the number of layers of the convolutional layers (filters), the filter size, the number of times of contraction and expansion, and the like. In S2901, the user sets the model structure (the CNN condition) similar to that of the inference unit 104 of the printer 100 to the learning apparatus 1901. In this process, the CPU 2001 of the learning apparatus 3001 may display the UI screen 2600 for the user to set the model structure.

In S2902, The CPU 2001 determines whether the automatic mode is selected by the user. For example, either the automatic or the manual mode is set by operating the mode selection button 2603 on the UI screen 2600. If the manual mode is selected, the process proceeds to S2904. The processing from S2904 to S2907 is similar to the processing from S2502 to S2505 in the second embodiment. If the automatic mode is selected, the process proceeds to S2903.

In S2903, the CPU 2001 of the learning apparatus 3001 (the apparatus condition obtainment unit 3002) requests the inference apparatus 3010 to provide the apparatus condition and receives the apparatus condition transferred from the inference apparatus 3010. As described above, the apparatus condition includes the speed condition 3013, the SRAM capacity 3014, and the padding condition 3015. The speed condition 3013 is the upper limit value of the printing speed, which is determined by the use case setting unit 3011 and held in the ROM 102. The SRAM capacity 3014 is the capacity (the circuit scale) of the SRAM used for the filter of the inference unit 104, which is stored in advance in the ROM 102.

In S2904, the CPU 2001 of the learning apparatus 3001 (the model condition determination unit 3003) determines the model condition based on the apparatus condition of the inference apparatus 3010 that is obtained in S2903 and sets the model condition to the model construction unit 3004. Since the designing of the CNN model is completed in S2901, in order to determine the model condition so as not to exceed the value of the SRAM capacity 3014, the CPU 2001 may adjust the division size of the image and an amount of the reference data in the margin data (hereinafter, abbreviated as a reference data amount).

In a case where the original image is divided finely, although the capacity of the image data transferred to and held in the RAM of the learning unit 2000 is less, the processing number of the margin data is increased according to the number of the divided images, and the processing speed becomes slow. In a case where the margin data is replaced with the padding, although the capacity of the image data transferred to and held in the RAM of the learning unit 2000 is less, the padding amount is increased, which causes decline in reliability of the learning, and as a result, the determination accuracy of the attribute probability in the inference is also declined. Accordingly, the CPU 2001 of the learning apparatus 3001 (the model condition determination unit 3003) determines the division size and the reference data amount that satisfy the speed condition 3013 and make the determination accuracy higher than a predetermined reference. In a case where multiple candidates are determined, the CPU 2001 of the learning apparatus 3001 may execute S2905 to S2907 for each of the multiple candidates and may set a candidate that obtains a result with the highest performance (the division size and the reference data amount) as the model condition.

Out of the model condition, as for the padding method 1924 and the padding position 1925, the padding condition 3015 (the padding method and the padding position) of the inference apparatus 3010 obtained in S2903 may be set. The division position 1921 may be determined based on the division size and the size of the original image determined in S2904. The reference data position 1923 is determined based on the range of the margin data and the padding position determined based on the condition of the CNN designed in S2901 and the reference data amount determined in S2904.

As above, once the model designing and the model condition setting are completed, and the learning start button 2602 of the UI screen 2600 is operated by the user, the process proceeds to S2905.

In S2905, the CPU 2001 initializes the filter coefficient. The CPU 2001 sets an arbitrary value to the filter coefficient of the size set by the model design. For example, a random value is set.

In S2906, the CPU 2001 sets the model condition and the filter coefficient to the learning unit 2000 and starts the learning. The same applies to the learning as that in the second embodiment. Once the learning is completed, the process proceeds to S2907. In S2907, the CPU 2001 outputs the learned filter coefficient that is the learning result. With the above processing, the present flowchart ends.

The inference apparatus 3010 obtains the learned filter coefficient from the learning apparatus 3001. The obtained learned filter coefficient is stored in the ROM 102 of the printer 100. Thus, the inference unit 104 of the printer 100 can execute the inference by using the learned filter coefficient generated by the learning apparatus 3001. This filter coefficient is determined by the learning to which the CNN condition in the inference is reflected and executed under the model condition determined based on the apparatus condition of the inference apparatus 3010. The model condition is determined based on the restrictions of the speed condition and the SRAM capacity requested by the inference apparatus 3010 so as to maintain the determination accuracy equal to or higher than a predetermined reference. Therefore, it is possible to execute the inference and suppress decline in reliability of the inference result even in the inference apparatus 3010 that has the restrictions of the speed condition and the SRAM capacity like embedded equipment.

### Modification of Third Embodiment

In the above-described third embodiment, an example in which the learning apparatus 3001 obtains the apparatus condition (the speed condition, the SRAM capacity, and the padding condition) of the inference apparatus 3010, and the model condition in the learning (the division size and the reference data amount) is determined is described. However, the present embodiment is not limited to this example, and the inference apparatus 3010 may determine the reference data obtainment condition based on the own apparatus condition and the model structure (the CNN condition) of the inference unit and transfer the reference data obtainment condition to the learning apparatus.

### System Configuration and Functional Configuration

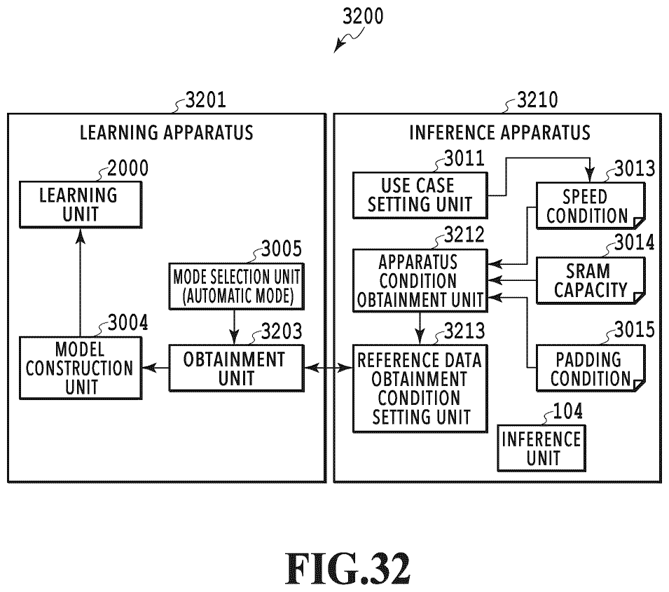

A system configuration and a functional configuration of an information processing system 3200 according a modification of the third embodiment is described. FIG. 32 is a diagram illustrating the system configuration and the functional configuration of the information processing system 3200 according to the modification of the third embodiment. As illustrated in FIG. 32, the information processing system 3200 includes an inference apparatus 3210 and a learning apparatus 3201, and the inference apparatus 3210 and the learning apparatus 3201 are communicably connected to each other via a data transfer unit or a communication unit of each apparatus. A hardware configuration of the learning apparatus 3201 is similar to that of the learning apparatus 1901 illustrated in FIG. 20. The inference apparatus 3210 is embedded equipment including the inference unit 104 and, for example, in a case where the inference apparatus 3210 is the printer 100 illustrated in FIG. 1, the hardware configuration is similar to that of the printer 100 illustrated in FIG. 1.

In the modification of the third embodiment, the learning apparatus 3201 includes the learning unit 2000, an obtainment unit 3203, the model construction unit 3004, and the mode selection unit 3005. The learning unit 2000, the model construction unit 3004, and the mode selection unit 3005 are similar to that in FIG. 30. The inference apparatus 3210 includes the inference unit 104, the use case setting unit 3011, an apparatus condition obtainment unit 3212, and a reference data obtainment condition setting unit 3213. Additionally, the ROM 102 or the DRAM 103 of the inference apparatus 3210 holds the speed condition 3013, the SRAM capacity 3014, and the padding condition 3015. The inference unit 104 and the use case setting unit 3011 are similar to that in FIG. 30.

In a case where the automatic mode is selected, the obtainment unit 3203 of the learning apparatus 3201 requests the inference apparatus 3210 to provide the reference data obtainment condition. Additionally, the obtainment unit 3203 receives the reference data obtainment condition transmitted from the inference apparatus 3210 and sets the reference data obtainment condition to the model construction unit 3004.

In a case of receiving the request to provide the reference data obtainment condition from the learning apparatus 3001, the reference data obtainment condition setting unit 3213 of the inference apparatus 3210 transmits the reference data obtainment condition of the inference apparatus 3210 to the learning apparatus 3201. First, the reference data obtainment condition setting unit 3213 obtains the apparatus condition including the speed condition 3013, the SRAM capacity 3014, and the padding condition 3015 held in the ROM 102 or the DRAM 103 by the apparatus condition obtainment unit 3212.

Based on the apparatus condition (the speed condition 3013 and the SRAM capacity 3014) of the inference apparatus 3210, the reference data obtainment condition setting unit 3213 of the inference apparatus 3210 determines the reference data obtainment condition in the inference unit 104 and transmits the reference data obtainment condition to the learning apparatus 3201. Specifically, the reference data obtainment condition setting unit 3213 determines the model condition, which is particularly the reference data obtainment condition, so as not to exceed the values of the speed condition 3013 and the SRAM capacity 3014 of the inference apparatus 3210.

The method of determining the model condition is similar to that in the above-described third embodiment. The reference data obtainment condition setting unit 3213 determines the reference data obtainment condition that does not exceed the value of the SRAM capacity 3014, satisfies the speed condition 3013, and makes the determination accuracy of the inference higher than a predetermined reference. The reference data obtainment condition setting unit 3213 transmits the determined reference data obtainment condition (the division size and the reference data amount) to the learning apparatus 3201.

The obtainment unit 3203 of the learning apparatus 3201 obtains the reference data obtainment condition transmitted from the inference apparatus 3210 and sets the reference data obtainment condition to the model construction unit 3004.

Out of the model condition set to the learning apparatus 3201, preferably, the padding method 1924 and the padding position 1925 are obtained from the inference apparatus 3210 as with the third embodiment. The division position 1921 is determined based on the division size and the size of the original image obtained as the reference data obtainment condition. The reference data position 1923 is determined based on the range of the margin data required for the convolutional computation and the padding position determined based on the condition of the CNN and a marginal area amount obtained as a marginal area condition.

As above, once the model designing and the model condition setting are completed, the learning unit 2000 executes the learning and optimizes the filter coefficient.

The filter coefficient generated in the present modification is transmitted from the learning apparatus 3001 to the inference apparatus 3210. The filter coefficient obtained by the inference apparatus 3210 is stored in the ROM 102 of the printer 100. Thus, the inference unit 104 of the inference apparatus 3210 can execute the inference by using the filter coefficient generated by the learning apparatus 3201. The filter coefficient is determined by the learning to which the CNN condition in the inference is reflected and executed under the model condition (particularly, the reference data obtainment condition) determined based on the apparatus condition of the inference apparatus 3210. Additionally, the model condition is determined based on the restrictions of the speed condition and the SRAM capacity requested by the inference apparatus 3210 and so as to maintain a predetermined accuracy. Therefore, it is possible to execute the inference and suppress decline in reliability of the inference result even in the inference apparatus 3210 that has the restrictions of the speed condition and the SRAM capacity like embedded equipment.

Note that, although an example in which the inference apparatus and the learning apparatus are communicably connected to each other via the data transfer I/F or the communication unit to transmit and receive the data is described in the third embodiment, the present disclosure is not limited thereto. The inference apparatus and the learning apparatus may be in an offline state and transmit and receive the data by using a transportable storage medium.

Additionally, the inference described in the first to the third embodiments is utilized in pattern recognition of two-dimensional image data and the like. That is, the feature amount of the two-dimensional image data is extracted by the CNN to determine the attribute probability indicating what the image of the two-dimensional image data is like, and the attribute probability is outputted as a pattern recognition result. Moreover, the inference and the learning described in the first to the third embodiments may be used for processing other than the pattern recognition.

Furthermore, although a case where the data as the processing target is two-dimensional image data and a two-dimensional filter is used for the filter coefficient is described in the first to the third embodiments, the present disclosure is not limited to this example. For example, the present disclosure is also applicable to a case where a one-dimensional filter is used for one-dimensional chronological data such as sound data. Additionally, the present disclosure is applicable similarly to data of an arbitrary dimension by generally applying a preferable configuration according to the dimension of the feature amount.

Additionally, the screen configuration of the UI screen, the displayed contents on the screen, the operation procedure, the operation method, and so on described in the embodiments are examples, and the present disclosure is not limited thereto. Moreover, although an example in which the functions of the inference unit and the learning unit in the above-described embodiments are implemented with the CPU executing the processing according to the program is described, it is not limited thereto, and an information processing apparatus other than the CPU (a processor such as a GPU) may be applied.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to reduce a storage capacity required for computation of a CNN while suppressing decline in reliability of a computation result.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-043546, filed Mar. 19, 2024, which is hereby incorporated by reference wherein in its entirety.

What is claimed is:

1. An information processing apparatus configured to execute inference using a convolutional neural network, comprising:
an obtainment unit configured to obtain target data from data for inference inputted in the information processing apparatus; and
a computation unit configured to execute convolutional computation and output computation result data, the convolutional computation using computation data including the target data obtained by the obtainment unit and margin data different from the target data that is required to obtain the computation result data in a predetermined size, wherein
according to a data obtainment condition set in advance, the obtainment unit obtains first data, which is a part of the margin data, from a data group existing around the target data separately from the target data in the data for inference and doses not obtain second data, which is the margin data except the first data, from the data group, and
a coefficient of the convolutional computation is determined by learning to which the data obtainment condition is reflected.

2. The information processing apparatus according to claim 1, further comprising:
a padding unit configured to pad the second data, which is data out of the margin data except the first data, according to a padding condition set in advance, wherein
the padding condition is additionally reflected to the learning.

3. The information processing apparatus according to claim 1, further comprising:
a holding unit configured to hold in advance the coefficient determined by the learning, wherein
the computation unit obtains the coefficient from the holding unit and executes the convolutional computation.

4. The information processing apparatus according to claim 1, wherein
the learning is executed by an apparatus different from the information processing apparatus.

5. The information processing apparatus according to claim 1, wherein
the data obtainment condition reflected to the learning includes a condition related to a position of the data group from which the obtainment unit obtains the first data.

6. The information processing apparatus according to claim 1, wherein
the data obtainment condition reflected to the learning includes a ratio of the first data to the margin data.

7. An information processing apparatus configured to execute learning using a convolutional neural network, comprising:
an obtainment unit configured to obtain target data from learning data inputted in the information processing apparatus; and
a computation unit configured to execute convolutional computation and output computation result data, the convolutional computation using computation data including the target data obtained by the obtainment unit and margin data different from the target data that is required to obtain the computation result data in a predetermined size, wherein
the obtainment unit obtains first data, which is a part of the margin data, from a data group existing around the target data separately from the target data in the learning data and doses not obtain second data, which is the margin data except the first data, from the data group.

8. The information processing apparatus according to claim 7, further comprising:
an acceptance unit configured to accept setting of a ratio of the first data to the margin data, wherein
the obtainment unit obtains the first data from the data group according to the ratio accepted by the acceptance unit.

9. The information processing apparatus according to claim 8, wherein
the acceptance unit additionally accepts setting of a model structure and a model condition of the convolutional neural network, and
the learning is executed by a learning model constructed based on the model structure and the model condition accepted by the acceptance unit.

10. The information processing apparatus according to claim 9, wherein
the acceptance unit displays a screen for a user to set the model structure, the model condition, and the ratio.

11. An information processing apparatus configured to execute learning using a convolutional neural network, comprising:
a communication unit configured to be communicably connected with an inference apparatus configured to execute inference;
an obtainment unit configured to obtain information to construct a model of the convolutional neural network from the inference apparatus connected via the communication unit; and
a construction unit configured to construct the model of the convolutional neural network based on the information obtained by the obtainment unit.

12. The information processing apparatus according to claim 11, wherein
the obtainment unit obtains an apparatus condition of the inference apparatus from the inference apparatus, and
the construction unit determines a model condition of the convolutional neural network based on the apparatus condition obtained by the obtainment unit and constructs the model of the convolutional neural network.

13. The information processing apparatus according to claim 12, wherein
the apparatus condition includes at least a memory capacity and a padding condition.

14. The information processing apparatus according to claim 13, wherein
the apparatus condition further includes a speed condition.
